(19) United States
(12) Patent Application Publication
(10) Pub. No.: US 2011/0259286 A1
(43) Pub. Date: Oct. 27, 2011

(54) Common rail slurry fuel injector system

(76) Inventor: Joseph Carl Firey, Seattle, WA (US)

(21) Appl. No.: 12/799,209

(22) Filed: Apr. 21, 2010

(51) Int. Cl. F02B 45/00; F16K 31/00; F02M 51/00; F02M 41/00; F02M 39/00; F02B 3/00; F02M 21/02

(52) U.S. Cl. 123/23; 123/299; 137/390; 123/525; 123/456; 123/445; 123/472; 701/103

(57) ABSTRACT

A fuel injection system is described for injecting slurry fuels into the combustion chamber of a diesel engine, equipped with a fuel common rail, and fitted with a gas to fuel contactor chamber for dissolving supplementary atomizing gas into the continuous phase of the slurry fuel, at high pressure. Each fuel injector comprises a combined double valve for starting and stopping fuel injection, so that slurry fuel containing atomizing gas is only depressurized when injected into the engine combustion chamber, when such depressurization greatly improves fuel atomization and combustion efficiency. In this way small bore, high speed, diesel engines can be efficiently operated on high viscosity, low cost fuels such as tars from tar sands, tars from coal and biomass, and residual petroleum fuels.

### CROSS REFERENCES TO RELATED APPLICATIONS

The invention described herein is related to my following US Patent Applications:
(1) U.S. Pat. No. 6,444,000, entitled, Steam Driven Fuel Slurrifier, issued 8 Sep. 2002.
(2) U.S. Pat. No. 7,677,791, entitled, Rotary Residual Fuel Slurrifier, issued 16 Mar. 2010.
(3) U.S. patent application Ser. No. 12/583,448, entitled, Rotary Tar Slurrifier, filed 21 Aug. 2009.

The above patents and applications describe apparatus for preatomizing high viscosity tars and residual fuels.
(4) U.S. Pat. No. 7,281,500, entitled, Supplementary Slurry Fuel Atomizer and Supply System, issued 16 Oct. 2007.
(5) U.S. Pat. No. 7,418,927, entitled, Common Rail Supplementary Atomizer for Piston Engines, issued 2 Sep. 2008.
(6) U.S. patent application Ser. No. 12/011,569, entitled, Modified Common Rail Fuel Injection System, filed 19 Jan. 2008.

The above patents and applications describe the use of contactor chambers and separate hydraulic fluid common rail for dissolving supplementary atomizing gas into the continuous phase of a slurry fuel.
(7) U.S. patent application Ser. No. 12/454,640, entitled, Engine Fuels from Coal Volatile Matter, filed 21 May 2009.
(8) U.S. patent application Ser. No. 12/590,333, entitled, Cyclic Batch Coal Devolatilization Apparatus, filed 6 Nov. 2009.
(9) U.S. patent application Ser. No. 12/653,189, entitled, Engine Fuels From Coal and Biomass Volatile Matter, filed 10 Dec. 2009.

These latter patent applications describe apparatus for deriving high viscosity fuels and tars, suitable for slurrification into slurry fuels from our large reserves of bituminous coal and also from non food farm harvest biomass materials.

The relation of several of these patents and applications to the Common Rail Slurry Fuel Injection system of this invention is described in the Description of the Preferred Embodiments.

### BACKGROUND OF THE INVENTION

Currently fuel injection systems, used on diesel engines, are required to carry out two necessary functions: atomize the fuel into the many small particles needed for rapid and efficient burning of the fuel; and distribute these many fuel particles approximately uniformly in the air mass in the engine combustion chamber, so that each fuel particle has access to the air needed for combustion. When lower cost, higher viscosity, fuels are to be used, higher fuel injection pressures, and resulting higher fuel jet velocities are needed, in order to achieve the needed small fuel particle sizes. At higher velocity, the fuel jet penetrates deeper across the engine combustion chamber. Thus to avoid fuel jet impact on the engine cylinder wall, larger engine cylinder diameter is needed when higher viscosity fuels are to be used.

For these reasons low cost, high viscosity, petroleum residual fuels are currently used only in large bore, very slow speed, marine diesel engines for cargo ships. The small bore high speed diesel engines, and medium bore medium speed diesel engines, used throughout our commercial surface transportation system, are obliged to use expensive, low viscosity, petroleum distillate fuels to avoid inefficient fuel combustion.

The residual fuel content of recently developed crude oil deposits has tended, on average, to increase with the passage of time. For example, the recently developed, and very large, Athabaska tar sands yield a crude oil which is essentially wholly residual tar fuel. Suitable distillate type fuels can be prepared from Athabaska tar and other residual fuels but substantial stock losses and energy efficiency losses result from the required tar processing.

A method of operating a major portion of our surface transportation industry on low cost tars and residual petroleum fuels, in place of high cost distillate petroleum fuels, increasingly in short supply, would be a substantial national benefit.

### SUMMARY OF THE INVENTION

Preatomizing a high viscosity tar or residual fuel, outside the diesel engine combustion chamber, into a slurry fuel comprising many small fuel particles, preatomized into a suspension within a continuous water phase, relieves the fuel injection system of the duty of atomizing the high viscosity fuel. The slurry fuel injection system can then be primarily designed to distribute these many small fuel particles, within the compressed combustion air mass in the engine cylinder, for optimum efficiency of combustion and engine work output.

During slurry fuel injection into the engine combustion chamber, aerodynamic forces will break up the slurry fuel jet into separate primary slurry fuel droplets, each of which will contain many separate preatomized fuel particles. The water phase evaporates from the surface of the slurry fuel primary droplets, thus leading to reagglomeration of the preatomized fuel particles into larger particles.

To avoid this undesirable reagglomeration of fuel particles, as well as to accelerate the water evaporation step, water soluble supplementary atomizing gas is dissolved into the continuous water phase of the slurry, at high pressure in a contactor chamber added to the common rail fuel injection system of this invention. When slurry fuel, containing supplementary atomizing gas, dissolved into the continuous phase at the high pressure in the contactor chamber, is injected into the relatively low pressure in the engine combustion chamber, the supplementary atomizing gas will expand out of solution in each primary slurry droplet, and separate the preatomized fuel particles, thus preventing undesirable reagglomeration of fuel particles.

In modern common rail fuel injection systems, two separate valves are interposed between the high pressure common rail and the fuel injector spray nozzle in order to take pressure off of the fuel injection valve between injections, and thus reduce the possibility of fuel leakage during engine exhaust and intake. Both the fuel injection valve and the separate fuel shut off valve are often opened and closed using the engine fuel from the common rail as a driving fluid. For the slurry fuel injection system of this invention a separate hydraulic fluid, at high pressure in a hydraulic fluid common rail, is used as the driving fluid for the opening and closing of both the fuel injection valve and the fuel shut off valve. Slurry fuel containing dissolved supplementary atomizing gas is thus not used for driving the fuel injection valve and the fuel shut off valve of this invention and the loss of compressed atomizing gas which would otherwise result is avoided.

After each fuel injection, any fuel trapped between the closed fuel injection valve and the closed fuel shut off valve is to be depressurized to avoid fuel leakage. For conventional distillate petroleum fuels such depressurization, even of a large fuel volume, does not create a problem. But, for a slurry fuel containing dissolved supplementary atomizing gas, either depressurization is incomplete due to pressure created by expanding atomizing gas, or, if the fuel injection valve is last to close, any appreciable trapped slurry fuel portion loses the benefit of supplementary atomizing gas before being injected into the engine cylinder. For the slurry fuel injection system of this invention a special double valve fuel injector is used wherein the fuel shut off valve and fuel injection valve, while operated separately, have a common sealing surface edge. As a result the volume of fuel trapped between these two valves can be vanishingly small.

In this way the economic and energy independence benefits of using low cost, high viscosity, residual fuels, and tar fuels, in the smaller bore, higher speed diesel engines used in our surface transportation industries can be fully realized. These surface transportation industries include railroads, tug and barge carriers, open pit mining operations, and farm plowing and harvesting operations.

### BRIEF DESCRIPTION OF THE DRAWINGS

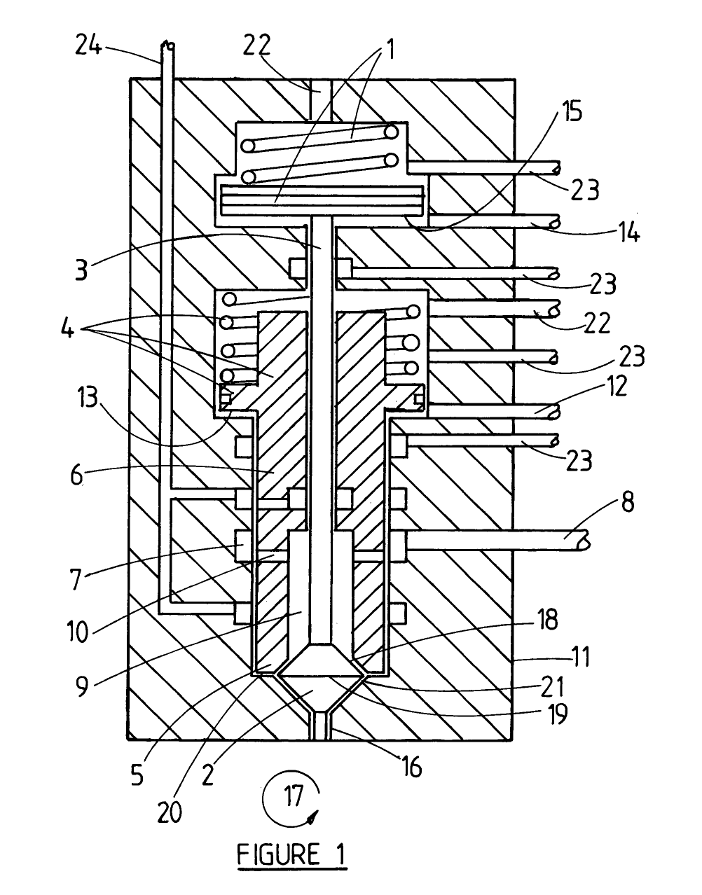

An example combined double valve fuel injector is shown in cross section in FIG. 1 together with the piston and spring drivers for separately opening and closing the fuel injection valve and the fuel shut off valve.

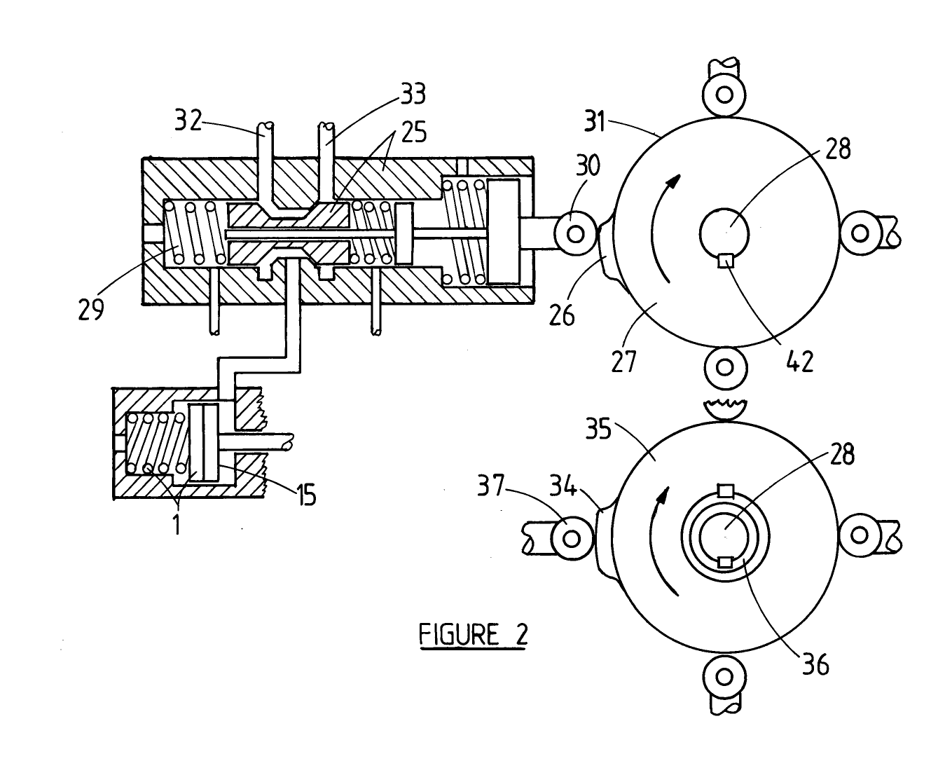

A mechanically timed pressure and vent valve is shown in cross section in FIG. 2 for operating the piston and spring drivers of the fuel injector double valves.

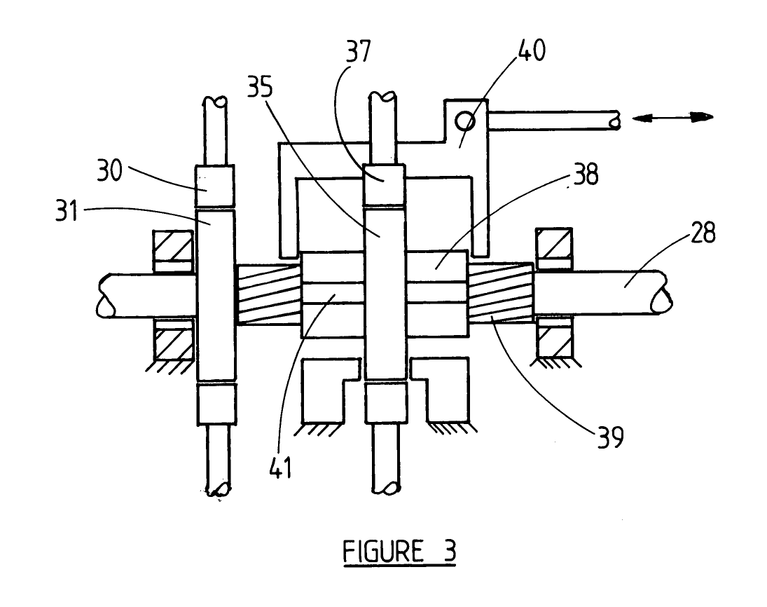

An example phase change gear is shown in FIG. 3 for mechanically adjusting the time interval between the start of fuel injection and the end of fuel injection in order to control fuel flow per engine cycle and hence engine torque.

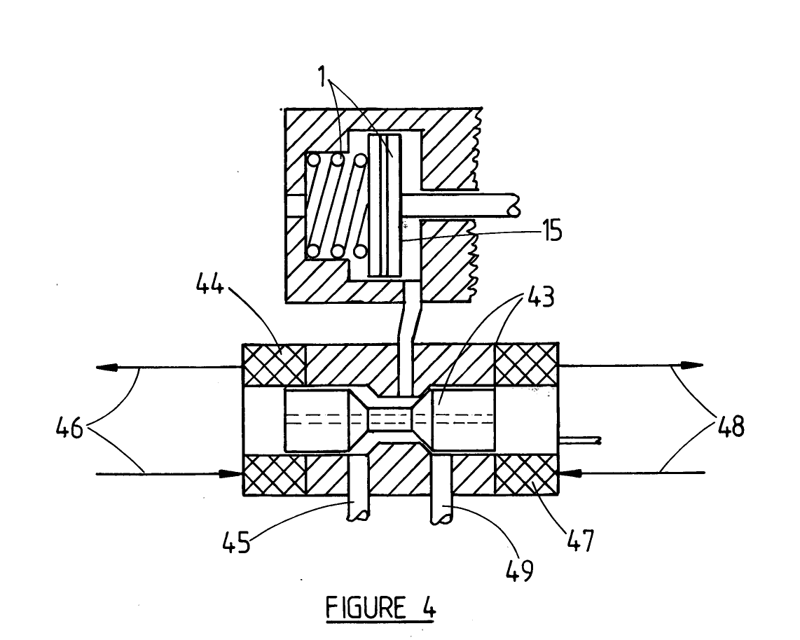

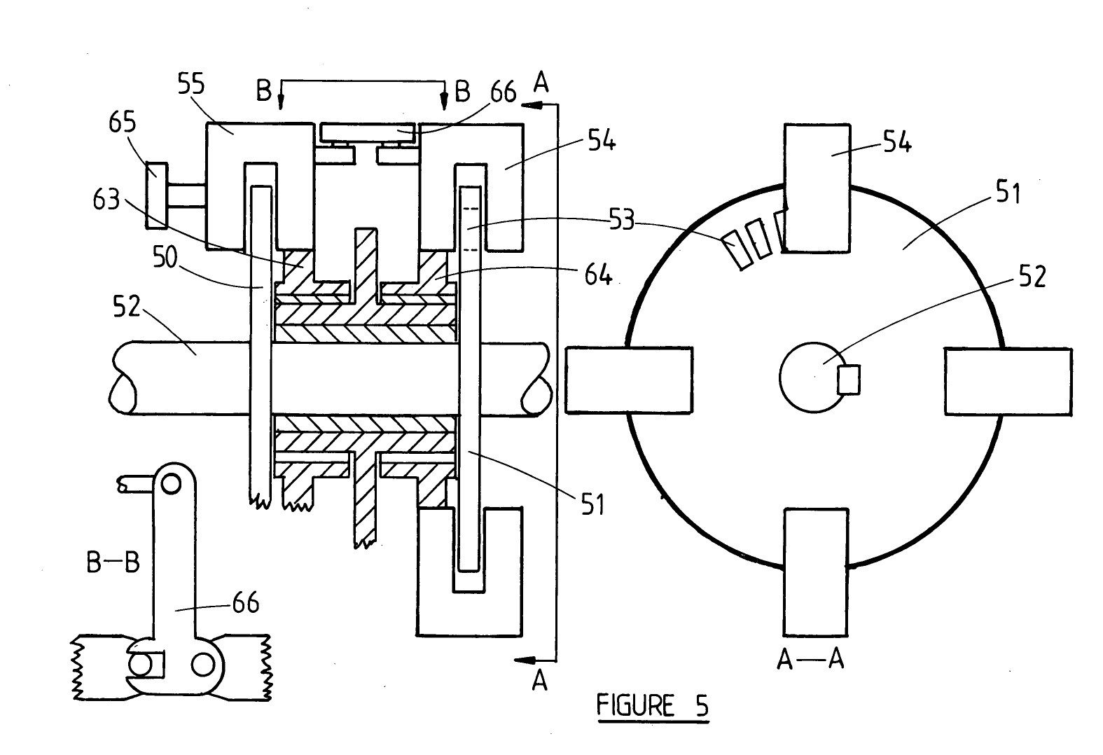

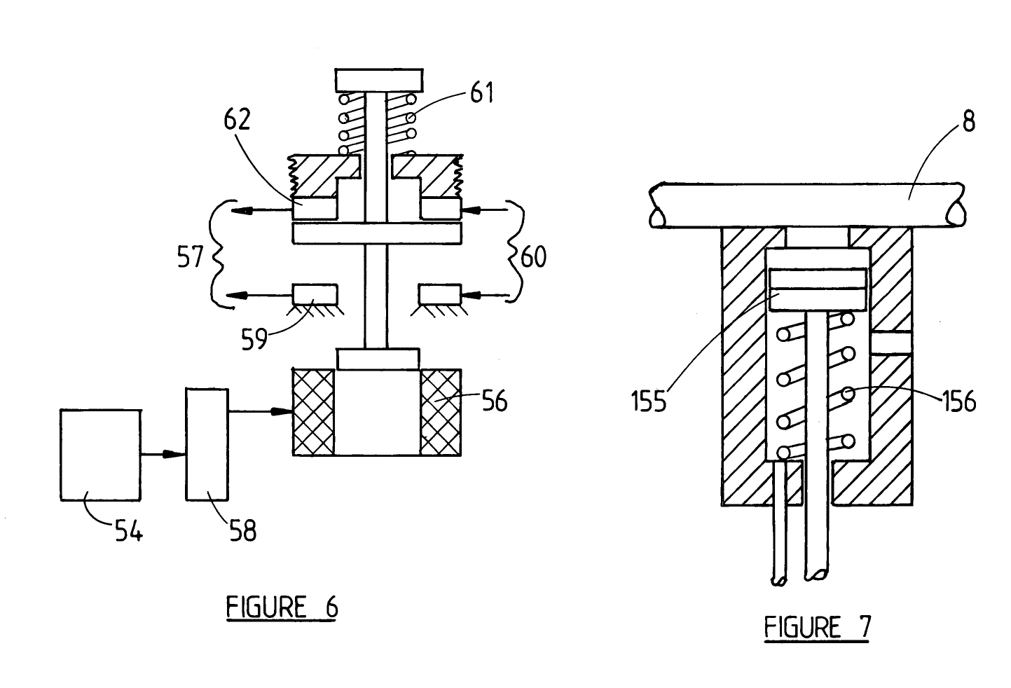

The pressure and vent valve shown in cross section in FIG. 4 is operated by solenoid drivers, timed by the lamp, photocell, and timer discs illustrated in FIG. 5, via the solenoid operated switch illustrated in FIG. 6.

A piston, cylinder and spring hydraulic accumulator is shown in FIG. 7 for minimizing slurry fuel pressure fluctuations during fuel injection.

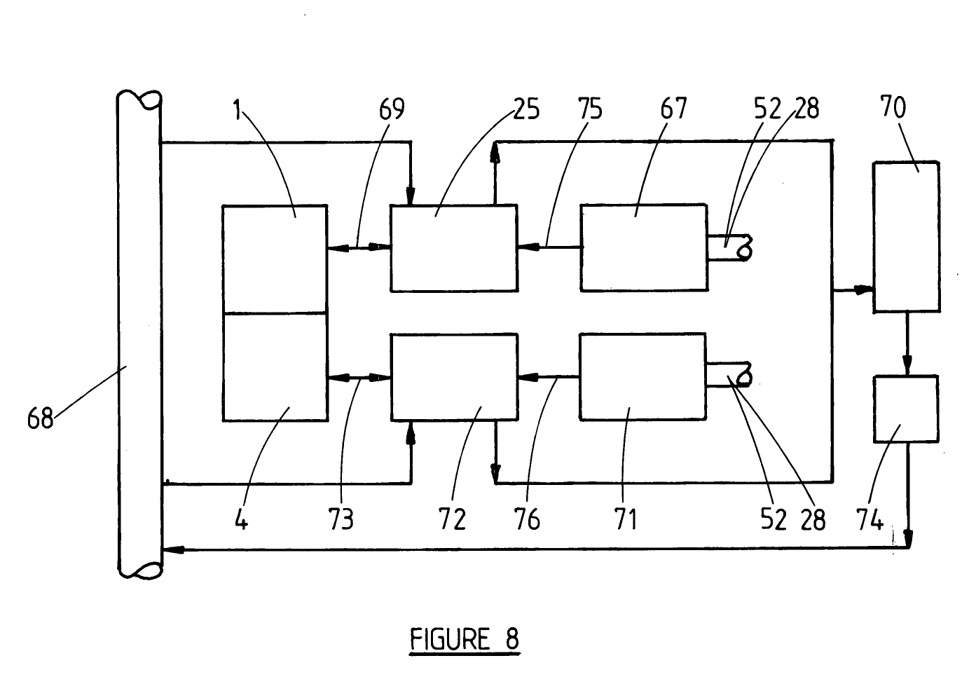

The schematic diagram of FIG. 8 illustrates the piping connections between the fuel injector, the pressure and vent valves, and the timer apparatus.

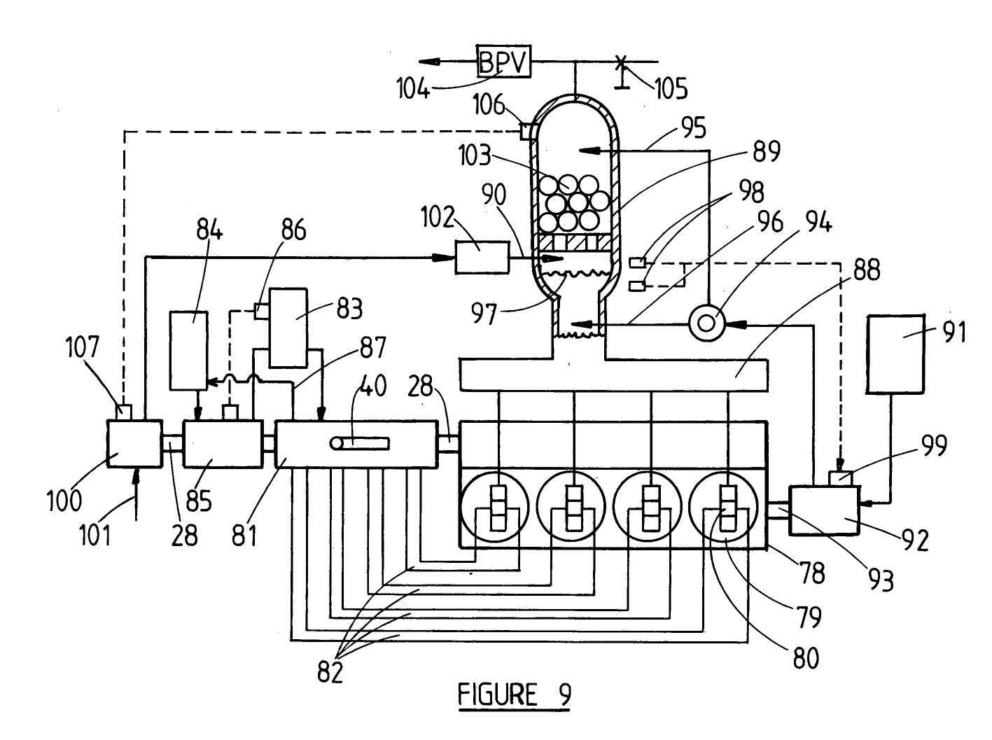

An example common rail slurry fuel injection system is shown schematically on FIG. 9, and includes a contactor chamber for dissolving supplementary atomizing gas into the continuous phase of the slurry fuel before passing this slurry fuel into the slurry fuel common rail.

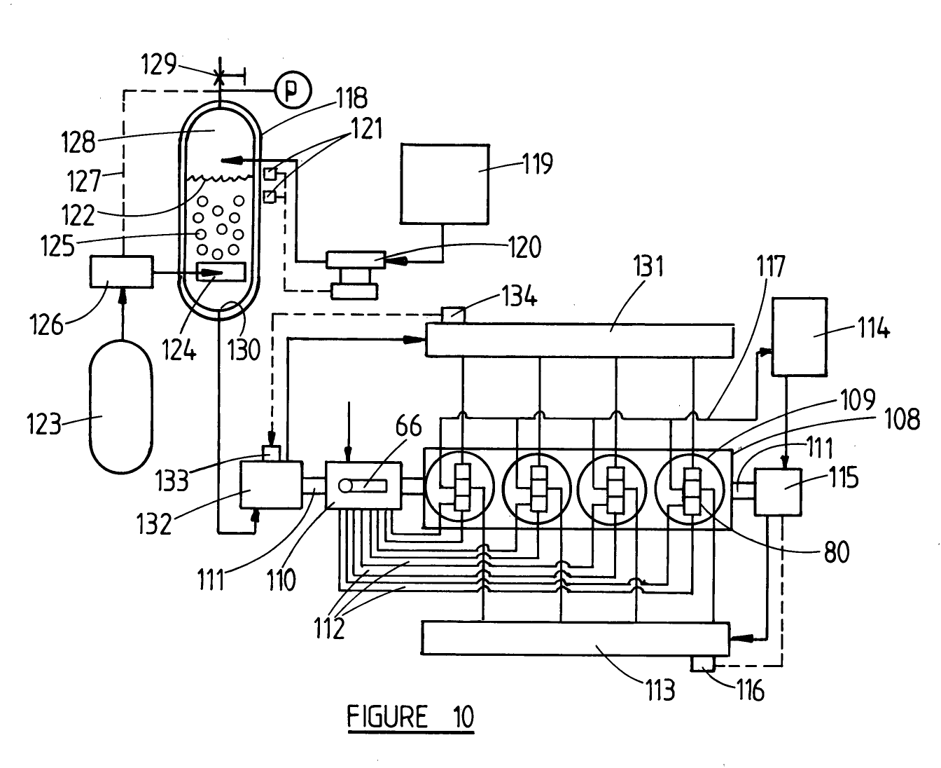

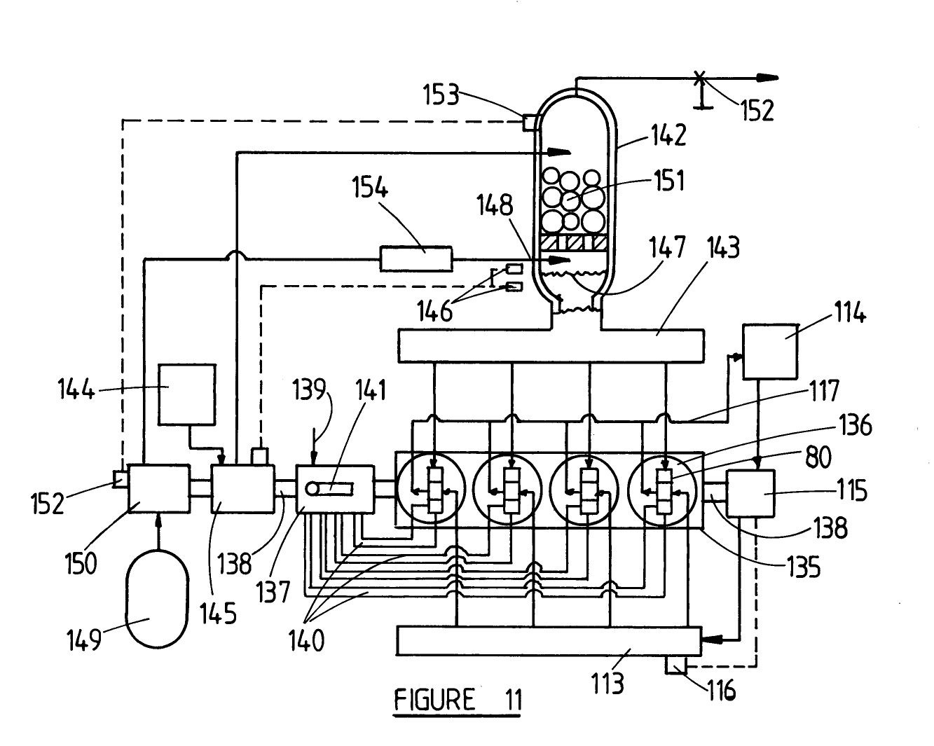

The example common rail slurry fuel injection system shown schematically in FIG. 10 illustrates the use of a hydraulic fluid common rail for the driving of the fuel injector double valves and a separate slurry fuel common rail to supply slurry fuel to the fuel injector.

The example common rail slurry fuel injection system shown schematically in FIG. 11 uses a high pressure gas pump to deliver supplementary atomizing gas into the contactor chamber to be dissolved into the continuous phase of the slurry fuel also flowing into the contactor chamber.

### DESCRIPTION OF THE PREFERRED EMBODIMENTS

The common rail slurry fuel injection system of this invention comprises a diesel engine fuel injection system, suitable for the efficient injection, of slurry fuels containing dissolved supplementary atomizing gas, into the combustion chamber of a diesel engine. This slurry fuel injection system comprises the following principal elements:
1) A combined double valve, fuel injector has a fuel injection valve, and a separate fuel shut off valve, with two separate valve driver systems for separately opening and closing the valves. One of the valve seating surfaces on the fuel injection valve shares a common edge with one of the valve seating surfaces on the fuel shut off valve.
2) A slurry fuel high pressure common rail comprises also a contactor chamber, within which high pressure slurry fuel from a slurry fuel pump, is contacted with supplementary atomizing gas, also at high pressure. Soluble atomizing gas thus becomes dissolved at high pressure into the continuous phase of the slurry fuel.
3) A non-fuel hydraulic fluid high pressure common rail receives hydraulic fluid from a high pressure hydraulic fluid pump. This high pressure hydraulic fluid, from the hydraulic fluid common rail, is used to operate the valve driver of the fuel injection valve, and to separately operate the valve driver of the fuel shut off valve.
4) A fuel injection timer system separately times the application of high pressure hydraulic fluid to the valve drivers of the fuel injection valve, and the fuel shut off valve, in order to separately time the start of fuel injection, into the engine combustion chamber, to be at best efficiency timing for the engine cycle, and to adjustably stop the fuel injection, in order to control fuel quantity injected per engine cycle, and thus to control engine torque.

Details of these principal elements, and other related elements are presented hereinbelow:

By using high pressure, non fuel, hydraulic fluid to operate the fuel injectors, instead of high pressure slurry fuel, containing dissolved atomizing gas, loss of high pressure atomizing gas during valve driver operation, is avoided, thus reducing the power loss to the compression of the atomizing gas.

The common valve seating edges, for the fuel injection valve, and the fuel shut off valve, can be used to assure that only that slurry fuel injected into the diesel engine combustion chamber undergoes the depressurization, and consequent atomizing gas expansion out of the continuous phase, needed to carry out the supplementary atomizing of each slurry fuel droplet.

Various types of slurry fuels can be used advantageously in combination with the common rail slurry fuel injection system of the invention, of which the following are examples:
a) Preatomized petroleum residual fuel particles, suspended in a continuous water phase, with a small number of high cetane number petroleum distillate particles as igniter fuel;
b) Preatomized coal tar and tar liquids particles, from the devolatilization of bituminous coals, suspended in a continuous water phase, with a small number of high cetane number petroleum distillate particles as igniter fuel;
c) Preatomized tar and tar liquids particles, from the devolatilization of non food farm harvest biomass material, suspended in a continuous water phase, with a small number of high cetane number petroleum distillate particles as igniter fuel;

Example methods of preparing these slurry fuels are described in my following US Patent Applications, and this material is incorporated herein by reference thereto:
1) U.S. patent application Ser. No. 11/796,714, entitled, Rotary Residual Fuel Slurrifier, filed 30 Apr. 2007; now standing allowed with issue fee paid;
2) U.S. patent application Ser. No. 12/583,448, entitled, Rotary Tar Slurrifier, filed 21 Aug. 2009;
3) U.S. patent application Ser. No. 12/454,640, entitled, Engine Fuels From Coal Volatile Matter, filed 21 May 2009;
4) U.S. patent application Ser. No. 12/590,333, entitled, Cyclic Batch Coal Devolatilization Apparatus, filed 6 Nov. 2009;
5) U.S. patent application Ser. No. 12/653,189, entitled, Engine Fuels from Coal and Biomass Volatile Matter, filed 10 Dec. 2009, a continuation-in-part of Ser. No. 12/454,640;

Various types of hydraulic fluids can be used with the common rail slurry fuel injection system of this invention, of which the following are examples:
d) Conventional hydraulic fluids as used in actuators on earth moving machinery;
e) Hydraulic brake fluid as widely used in car and truck braking systems;
f) Well filtered engine crankcase lubricating oil;

The supplementary atomizing gas is selected to be at least partially, and preferably largely, soluble in the continuous phase of the slurry fuel. Many gases are at least partially soluble in a water continuous phase, such as the following examples:
g) Carbon dioxide is highly water soluble, and only the impurities would be insoluble;
h) The oxygen portion of atmospheric air is moderately water soluble, but the larger nitrogen portion is only slightly water soluble;
i) The carbon dioxide and oxygen portions of diesel engine exhaust gas are soluble in water and are readily available from the diesel engine but require appreciable cooling.
j) Commercial purity oxygen will be largely water soluble, but may present an explosion hazard in the presence of fuels at the high pressures in the slurry fuel common rail;

Where distillate petroleum fuel is the continuous phase of a slurry fuel, natural gas can be efficiently used as a supplementary atomizing gas;

### The Combined Double Valve Fuel Injector

A cross sectional drawing of a combined double valve fuel injector is illustrated schematically in FIG. 1.The piston cylinder and spring driver, 1, opens and closes the fuel injection valve, 2, via the fuel injection valve shaft, 3. A separate piston cylinder and spring driver, 4, opens and closes the fuel shut off valve, 5, via the fuel shut off valve shaft, 6.

These elements are sealably enclosed within the stationary fuel injector body, 11. High pressure slurry fuel, containing dissolved atomizing gas in the continuous phase, enters the fuel manifold, 7, via the slurry fuel connector, 8, from a high pressure slurry fuel common rail, and flows into the intershaft fuel flow passage, 9, via fuel passages, 10.

Admission of high pressure hydraulic fluid, from a hydraulic fluid common rail, via connection, 12, to the opening aide, 13, of the fuel shut off valve driver piston, 4, opens the fuel shut off valve, 5, against the driver spring, 4, and admits high pressure slurry fuel to the fuel injector valve, 2.

Subsequent admission of high pressure hydraulic fluid, from the hydraulic fluid common rail, via connection, 14, to the opening side, 15, of the fuel injection valve driver piston, 1, opens the fuel injection valve, 2, against the driver spring, 1, and admits high pressure slurry fuel to the fuel injection nozzle, 16, and from there into the engine combustion chamber, 17.

Adjustable venting of hydraulic fluid from the opening side, 13, of the fuel shut off valve driver piston, 4, via connection, 12, allows the driver spring, 4, to close the shut off valve, 5, against a back seat, 18, on the fuel injection valve head, 19, and slurry fuel flow to the fuel injection valve, 2, and hence into the engine combustion chamber, 17, is stopped. The time interval between a fixed opening time of the fuel injection valve, 2, and the subsequent adjustable closing of the fuel shut off valve, 5, can be varied as a method of adjusting the fuel quantity injected into the engine combustion chamber during each engine cycle, in order to adjust engine torque output.

The opening lift of the fuel shut off valve, 5, is to be appreciably greater than the opening lift of the fuel injection valve, 2, so that opening of the fuel injection valve does not close the fuel shut off valve.

Subsequent venting of hydraulic fluid from the opening side, 15, of the fuel injection valve driver piston, 1, via connection, 14, allows the driver spring, 1, to close the fuel injection valve, 2. The fuel shut off valve, 5, remains closed while moving down with the closing fuel injection valve head, 19, to force essentially all slurry fuel out of the bottom of the fuel injector, beyond the fuel shut off valve. The clearance between the lower end, 20, of the fuel shut off valve, 5, and the fuel injector body, 11, when the fuel injection valve is closed, is finite but small. The two valve seating areas on the fuel injection valve head, 19, share a common outer radius, 21. With these arrangements, essentially the only slurry fuel undergoing depressurization, and the needed supplementary atomization due to expansion of atomizing gas out of the continuous phase, is that slurry fuel injected into the diesel engine combustion chamber, 17.

A pintle type fuel injection nozzle, 16, is shown in FIG. 1, but other types of fuel injection nozzle can be used, such as multihole fuel injection nozzles.

Driver spring chambers are vented to atmosphere via vents, 22, and hydraulic fluid leakage is collected and returned via connections, 23, to the hydraulic fluid reservoir. Similarly slurry fuel leakage is collected and returned via connections, 24, to the slurry fuel tank.

The fuel shut off valve shaft also functions as a spring loaded piston and cylinder fluid accumulator to reduce pressure fluctuations within the intershaft fuel flow passage, 9, during fuel injection. A supplementary piston, cylinder, and spring fluid accumulator, as shown schematically on FIG. 7, can be connected to the slurry fuel connector, 8, to additionally reduce pressure fluctuations during fuel injection. Slurry fuel at pressure forces the piston, 155, to compress the vented spring, 156, and these then act to offset pressure fluctuations within the connected fuel injector.

### Mechanical Fuel Injection Timing

Injection of slurry fuel into the diesel engine combustion chamber is to start at, or near, to best efficiency timing for the diesel engine cycle, by opening the fuel injection valve, the fuel shut off valve having been opened somewhat earlier. Two separate pressure and vent valves are operated by separate timer units, and the timer units are driven by the crankshaft for two stroke cycle engines, or by the camshaft for four stroke cycle engines.

An example diagram of mechanical pressure and vent valves, operated by camshaft driven timer cams, is illustrated schematically in FIG. 2 and FIG. 3, for separately operating each driver of the fuel injection valve, and each driver of the fuel shut off valve, of a four cylinder, four stroke cycle diesel engine.

One fuel injection valve pressure and vent valve, 25, is shown opened to the hydraulic fluid pressure connection, 32, by the fuel injection valve timer cam, 26, on the fuel injection valve timer cam plate, 27, rotated by the engine camshaft, 28, at one half of engine RPM. High pressure hydraulic fluid thus acts on the opening side, 15, of the fuel injection valve driver piston, 1, to open the fuel injection valve, 2, and compress the driver spring, 1. Slurry fuel is then injected into the engine combustion chamber. Subsequently, when the cam follower, 30, is returned to the base circle, 31, of the cam plate, 27, the timer spring, 29, moves the pressure and vent valve, 25, to close the hydraulic fluid pressure connection, 32, and to open the hydraulic fluid vent connection, 33. The driver spring, 1, then closes the fuel injection valve, 2, and vents the spent hydraulic fluid back to the hydraulic fluid supply tank via the vent connection, 33. A single fuel injection valve timer cam and plate can also operate the pressure and vent valves for the other three engine cylinder fuel injectors of this FIG. 2 example, and only these cam followers are shown.

An entirely similar fuel shut off valve pressure and vent valve can be mechanically driven by the fuel shut off valve timer cam, 34, on the fuel shut off valve timer cam plate, 35, rotated by the engine camshaft, 28, via the helical spline sleeve and gear angular phase change unit, 36, shown schematically in FIG. 3 in greater detail. This fuel shut off valve pressure and vent valve is not shown on FIG. 2, but would be driven by the cam follower, 37, to open the fuel shut off valve before the fuel injection valve, and to close the fuel shut off valve adjustably earlier than the fuel injection valve. As a result the fuel shut off valve timer cam, 34, has a wider arc of lift than the fuel injection valve timer cam, 26. A single fuel shut off valve timer cam and plate can also operate the pressure and vent valves for the other three engine cylinder fuel injection of this FIG. 2 example, and only these cam followers are shown.

As shown on FIG. 3, the moveable helical spline sleeve, 38, has internal helical gear teeth which mesh with the teeth of the helical gear, 39, on the engine camshaft, 28. The helical spline sleeve, 38, can be adjusted, in the direction of the camshaft centerline, by the torque control lever, 40, relative to the helical gear, 39, and drives the fuel shut off valve timer cam plate, 35, via the key, 41, thus adjusting the angular phase relation of the fuel shut off valve timer cam plate, 35, to the camshaft, 28. As shown on FIG. 2, the angular phase relation of the fuel injection valve timer cam plate, 27, to the camshaft, 28, is fixed by the key, 42. Since fuel injection into the engine combustion chamber, is started by the opening of the fuel injection valve, and is ended by the closing of the fuel shut off valve, adjustment of the angular phase relation between the fuel injection valve timer cam plate, 27, and the fuel shut off valve timer cam plate, 35, can be used to adjust the duration of fuel injection and thus to adjust both fuel quantity injected per engine cycle and hence engine torque.

Other types of angular phase adjustors can be used for thus controlling engine torque as are well known in the art of mechanical phase adjustors.

In this way the slurry fuel shut off valve, 5, is timed relative to the slurry full injection valve, 2, as follows:
(1) Fuel shut off valve is opened before the fuel injection valve;
(2) The fuel injection valve is next opened at or near to best fuel efficiency timing for the diesel engine cycle;
(3) The fuel shut off valve is adjustably closed before closure of the fuel injection valve to control engine torque;
(4) The fuel injection valve is closed after closure of the fuel shut off valve.

Best efficiency timing of fuel injection can vary with engine speed. Thus for diesel engines operated over a wide speed range an angular phase adjustor may also be preferred between the fuel injection valve timer cam plate, 27, and the engine camshaft, 28, to be adjusted by an engine speed sensor.

### Electrical Fuel Injection Timing

Solenoid or solenoid and spring operators of the pressure and vent valve can be used for electrical slurry fuel timers, an example of which is shown schematically in FIG. 4. The pressure and vent valve, 43, is made of steel or other magnetic material, and is shown as connected to the driver piston and spring, 1, for opening and closing the fuel injection valve.

When the valve opener solenoid, 44, is alone energized by electric power, via connections, 46, the pressure and vent valve, 43, opens to only connect the hydraulic fluid pressure connection, 45, to the valve opening side, 15, of the fuel injection valve driver piston, 1, and high pressure hydraulic fluid, from the hydraulic fluid common rail, acts to open the fuel injection valve.

When the valve closer solenoid, 47, is alone energized by electric power, via connections, 48, the pressure and vent valve, 43, moves to only connect the hydraulic fluid vent connection, 49, to the opening side, 15, of the fuel injection valve driver piston, 1, and hydraulic fluid is forced out of the closing side, 15, by the fuel injection valve driver spring, 1, and the fuel injection valve closes.

A particular example fuel injection timing unit is shown schematically in FIG. 5 and FIG. 6, for a four cylinder, two stroke cycle diesel engine. Two separate timer discs are used, a fuel injection valve timer disc, 50, and a fuel shut off valve timer disc, 51, both of which are rotating by the engine crankshaft, 52. Each timer disc has one or more shutter openings, 53, with an equal number on each disc. The electrical energy, to operate each pressure and vent valve, of each fuel shut off valve, is created by a lamp and photocell unit, 54, straddling the fuel shut off valve timer disc, 51, one for each pressure and vent valve. Similarly the electrical energy, to operate each pressure and vent valve of each fuel injection valve, is created by a separate lamp and photocell unit, 55, which straddles the fuel injection valve timer disc, 50. The lamp and photocell, in each unit, are aligned to each other, and to the shutter openings, 53, so that light from the lamp reaches the photocell only when a shutter opening, 53, crosses the light path between the lamp and the photocell. The resulting electric power pulse from the photocell, 54, energizes the solenoid, 56, on the FIG. 6 power switch, 57, either directly, or via a power pulse amplifier, 58, to close the valve opener switch, 59, which sends a power pulse from the power source, 60, to the valve opening solenoid, 44, of FIG. 4, resulting in opening of the fuel shut off valve, 5. When a shutter opening is no longer crossing the light path between the lamp and the photocell, the electric power is turned off to the solenoid, 56, on the power switch, 57, and the power switch spring, 61, closes the valve closer switch, 62, which sends power to the closing solenoid, 47, of the pressure and vent valve, 43, resulting in closing of the fuel shut off valve, 5.

In this same way, the fuel injection valve timer disc, 50, with shutter openings crossing the light path between a lamp and a photocell, functions to open and close the fuel injection valve, 2.

A single fuel injection valve shutter disc, in combination with a separate single fuel shut off valve shutter disc, can serve all engine cylinders, with separate lamp and photocell units for each combustion chamber. All fuel injection valve lamp and photocell units are secured to a common fuel injection valve bracket, 63, and all fuel shut off valve lamp and photocell units are secured to a separate fuel shut off valve bracket, 64, and these brackets can be separately angularly adjusted about the centerline of the engine crankshaft, 52. All shutter openings are at the same radius as the light path between lamp and photocell. Where more than one shutter opening is used, the number of shutter openings is equal on both timer discs and the shutter openings on the full shut off valve timer disc have the same angular spacing as the corresponding shutter openings on the fuel injection valve timer disc. Shutter openings on the fuel shut off valve timer disc are angularly wider than the corresponding shutter openings on the fuel injection valve timer disc. Pulsed fuel injection can be obtained by use of several shutter openings on each timer disc. The start of fuel injection into the engine combustion chamber can be adjusted to best engine cycle efficiency timing by angular adjustment of the fuel injection valve bracket, 63, via lever, 65. The duration of fuel injection, and thus fuel quantity injected per engine cycle and hence the engine torque, can be adjusted by adjusting the phase angle between the fuel injection valve timer disc, 50, and the fuel shut off valve timer disc, 51, via the torque control lever, 66, shown in section B-B of FIG. 5. In this way the fuel shut off valve, 5, can be timed relative to the fuel injection valve, 2, as follows:
(1) The fuel shut off valve is opened before the fuel injection valve;
(2) The fuel injection valve is next opened at or near best fuel efficiency timing for the diesel engine cycle;
(3) The fuel shut off valve is adjustably closed before closure of the fuel injection valve to control engine torque;
(4) The fuel injection valve is closed after closure of the fuel shut off valve.

The pressure and vent valve, 43, shown in FIG. 4 uses two separate solenoid operators, a valve opener solenoid, 44, and a valve closer solenoid, 47. An alternative operator of the pressure and vent valve could use a single solenoid in combination with a return spring. For this combination operator of the pressure and vent valve, 43, the extra valve closer switch, 62, on FIG. 6, is not needed.

### The FIG. 9 Example Slurry Fuel Injection System

The slurry fuel injection system shown schematically in FIG. 9, is operative on a four cylinder, four stroke cycle diesel engine, 78, and comprises the following principal elements:
(1) The combustion chambers in each of the four engine cylinders, 79, are equipped with a combined double valve fuel injector, 80, similar to that illustrated in FIG. 1, and described hereinabove.
(2) A mechanical cam operated timer unit, 81, is driven by the engine camshaft, 28, and is similar to that illustrated in FIG. 2 and FIG. 3, and described hereinabove. The pressure and vent valves, 25, are thus located at the timer unit, 81, and connect to the fuel injectors, 80, via pressure and vent piping, 82. The torque control lever, 40, adjusts the phase angle between the fuel injection valve cam, 31, and the fuel shut off valve cam, 35, shown in FIG. 2.
(3) High pressure hydraulic fluid is delivered to the pressure connections of each pressure and vent valve from the high pressure common rail, 83, which receives hydraulic fluid from the hydraulic fluid tank, 84, via the high pressure hydraulic fluid pump, 85, driven from the engine camshaft, 28, and controlled by the pressure sensor, 86, on the high pressure hydraulic fluid common rail, 83. Vented hydraulic fluid from the pressure and vent valves is returned to the hydraulic fluid tank, 84, via vent pipe, 87, to complete the hydraulic fluid cycle.
(4) The slurry fuel common rail, 88, with contactor chamber, 89, and supplementary atomizing gas inlet, 90, is similar to that described in my U.S. Pat. No. 7,418,927B2, issued 2 Sep. 2008, and this material is incorporated herein by reference thereto. Slurry fuel from the slurry fuel tank, 91, is delivered into the contactor chamber, 89, by the slurry fuel pump, 92, driven by the engine crankshaft, 93, via the flow divider, 94. The flow of slurry fuel is thus divided into a portion, delivered via connection, 95, into the upper portion of the contactor chamber, 89, and another portion, delivered via connection, 96, into the lower portion of the contactor chamber, 89, and below the slurry fuel level, 97, maintained in the contactor chamber, 89, by the fluid level sensors, 98, and slurry fuel pump, 92, controller, 99.
(5) Atmospheric air is used as supplementary atomizing gas for this FIG. 9 example slurry fuel injection system. Air enters the high pressure air compressor, 100, via connection, 101, where it is compressed, with intercooling, to contactor chamber, 89, pressure, which is essentially slurry fuel injection pressure into the engine combustion chamber. This high pressure air is further cooled by the cooler, 102, and delivered into the contactor chamber, 89, below the packing material, 103, in the contactor chamber, and above the slurry fuel level, 97. The downflowing slurry fuel is spread out over the packing material and thus in close contact with the upflowing air. The oxygen portion of the air is moderately soluble in a water continuous phase of the slurry fuel, and is substantially thusly dissolved thereinto within the contactor chamber, 89. The low solubility nitrogen portion of the air is discharged from the top of the contactor chamber via the back pressure control valve, 104. Alternatively, an adjustable area flow restrictor, 105, can be used, in combination with a contactor chamber pressure sensor, 106, and air compressor controller, 107, to control contactor chamber pressure.
(6) The downflowing slurry fuel portion thus becomes approximately saturated with oxygen in the continuous phase and is then blended into that slurry fuel portion delivered below the slurry fuel level, 97, in the contactor chamber. In this final blended slurry fuel the continuous water phase is less than saturated with dissolved oxygen, and gas expansion can be avoided throughout the high pressure slurry fuel piping, until the slurry fuel is injected into the lower pressures in the engine combustion chamber.
(7) Slurry fuel, with supplementary atomizing gas, thusly dissolved into the continuous phase, is delivered to each slurry fuel injector, 80, from the slurry fuel common rail, 88. Slurry fuel injection into each engine combustion chamber starts when the fuel injection valve is opened by the timer unit, 81, and ends when the fuel shut off valve is closed by the timer unit, 81.
(8) Instead of the back pressure valve, 104, a work recovery engine can be used to control contactor chamber pressure, resulting in improved fuel efficiency as is shown on FIG. 4 of U.S. Pat. No. 7,418,927 and described therein in columns 9 and 10.

### The FIG. 10 Example Slurry Fuel Injection System

The slurry fuel injection system shown schematically in FIG. 10, is operative on a four cylinder, two stroke cycle diesel engine, 108, and comprises the following principal elements:
(1) The combustion chamber in each of the four engine cylinders, 109, are equipped with a combined double valve fuel injector, 80, similar to that illustrated in FIG. 1, and described hereinabove;
(2) An electrical fuel injection timer unit, 110, using a lamp, photocell, and timer discs power pulse generator, is driven by the engine crankshaft, 111, and is similar to that illustrated in FIG. 4, FIG. 5, and FIG. 6, and described hereinabove. The pressure and vent valves, 43, are solenoid driven and located directly on the fuel injector, 80, and connect to the electrical timer unit, 110, via electric cables, 112. The torque control lever, 66, adjusts the phase angle between the fuel injection valve timer disc, 50, and the fuel shut off valve timer disc, 51, as shown in FIG. 5, and described hereinabove. Electric power is supplied to the timer unit, 110, from an external source, such as an engine driven electric generator or a battery;
(3) High pressure hydraulic fluid is delivered to the pressure connections of each pressure and vent valve from the high pressure common rail, 113, which receives hydraulic fluid from the hydraulic fluid tank, 114, via the high pressure hydraulic fluid pump, 115, driven from the engine crankshaft, 111, and controlled by the pressure sensor, 116, on the high pressure hydraulic fluid common rail, 113. Vented hydraulic fluid from the pressure and vent valves is returned to the hydraulic fluid tank, 114, via vent pipe, 117, to complete the hydraulic fluid cycle;
(4) The slurry fuel separate contactor chamber, 118, for contacting slurry fuel with supplementary atomizing gas, is similar to that described in my U.S. Pat. No. 7,281,500B1, issued 16 Oct. 2007, and this material is incorporated herein by reference thereto. Slurry fuel from the slurry fuel tank, 119, is delivered into the upper portion of the contactor chamber, 118, by the slurry fuel pump, 120, driven by various drivers, such as an electric motor or the engine crankshaft, 111. The pump, 120, is controlled by the sensors, 121, of slurry fuel level, 122, within the contactor chamber, 118, to maintain an essentially constant fluid level therein, well above the midheight of the contactor chamber.
(5) High pressure and high purity carbon dioxide is used as supplementary atomizing gas, for this FIG. 10 example slurry fuel injection system, and is supplied from the high pressure carbon dioxide tank, 123, at a pressure well above contactor chamber, 118, pressure. The carbon dioxide gas enters the lower portion of the contactor chamber via a gas bubble chamber, 124. The many resulting carbon dioxide bubbles, 125, rise through the downflowing slurry fuel and most of the carbon dioxide can be dissolved into the continuous water phase of the slurry fuel, as supplementary atomizing gas. The flow controller, 126, responsive to a pressure signal, 127, from the top of the contactor chamber, controls the flow rate of carbon dioxide gas so that an essentially constant pressure is maintained in the contactor chamber, 118.
   Insoluble impurities in the carbon dioxide gas supply, 123, will accumulate in the space, 128, above the slurry fuel level, 122, and can be periodically or continually discharged via an adjustable gas bleed flow restrictor, 129. Carbon dioxide is highly soluble in water and the continuous water phase of the slurry fuel leaving the bottom, 130, of the contactor chamber, 118, is very nearly saturated with supplementary atomizing gas at contactor chamber pressure.
(6) Slurry fuel, with thusly dissolved carbon dioxide gas, is pumped into a higher pressure in the slurry fuel common rail, 131, by the engine crankshaft, 111, driven common rail slurry fuel pump, 132, and is delivered via the common rail, to each slurry fuel injector 80. The common rail pump, 132, is controlled by the controller, 133, responsive to the common rail pressure sensor, 134, to maintain an essentially constant pressure in the slurry fuel common rail. This slurry fuel common rail pressure is essentially the pressure at which fuel is injected by the slurry fuel injector, 80, into the engine combustion chamber. Since common rail pressure exceeds contactor chamber pressure the slurry fuel in the common rail is no longer saturated, and the gas expansion can be avoided throughout the common rail slurry fuel piping, until the slurry fuel is injected into the lower pressure in the engine combustion chamber.
(7) Slurry fuel injection into each engine combustion chamber starts when the fuel injection valve is opened by the electrical timer unit, 66, and ends when the fuel shut off valve is closed by the electrical timer unit, 66.
(8) Contactor chamber pressure, while less than common rail pressure, is nevertheless appreciably greater than maximum pressure in the engine combustion chamber.

### The FIG. 11 Example Slurry Fuel Injection System

The slurry fuel injection system shown schematically in FIG. 11, is operative on a four cylinder, two stroke cycle diesel engine, 135, and comprises the following principal elements:
(1) The combustion chamber in each of the four engine cylinders, 136, are equipped with a combined double valve fuel injector, 80, similar to that illustrated in FIG. 1, and described hereinabove;
(2) An electronic fuel injection timer unit, 137, is timed by the engine crankshaft, 138, and energized by an electric power source, 139. The pressure and vent valves, 43, are solenoid driven, as illustrated in FIG. 4, or solenoid and spring driven, and are located directly on the fuel injector, 80, and connect to the electronic timer unit, 137, via electric cables, 140. The torque control lever, 141, introduces an adjustable time interval between the electronic power pulse, which opens the fuel injection valve, and the subsequent electronic power pulse, which closes the fuel shut off valve, in order to adjust the slurry fuel quantity injected per engine cycle, and thus to control engine torque;
(3) High pressure hydraulic fluid is delivered to the pressure connections of each pressure and vent valve from the high pressure common rail, 113, which receives hydraulic fluid from the hydraulic fluid tank, 114, via the hydraulic fluid high pressure pump, 115, driven from the engine crankshaft, 138, and controlled by the pressure sensor, 116, on the high pressure hydraulic fluid common rail, 113. Vented hydraulic fluid from the pressure and vent valves is returned to the hydraulic fluid tank, 114, via vent pipe, 117, to complete the hydraulic fluid cycle;
(4) The slurry fuel contactor chamber, 142, for contacting slurry fuel with supplementary atomizing gas, is open flow connected to the high pressure slurry fuel common rail, 143. Slurry fuel from the slurry fuel tank, 144, is delivered into the upper portion of the contactor chamber, 142, by the high pressure slurry fuel pump, 145, driven by the engine crankshaft, 138. Slurry fuel is delivered into the contactor chamber above the packing material, 151, therein, and flows downward over the large area of the packing material into the bottom portion of the contactor chamber. The pump, 145, is controlled by the sensors, 146, of slurry fuel level, 147, within the contactor chamber, 142, to maintain an essentially constant fluid level therein, below the level, 148, at which supplementary atomizing gas is delivered into the lower portion of the contactor chamber, 142.
(5) Carbon dioxide gas is used as supplementary atomizing gas, for this FIG. 11 example slurry fuel injection system, and is pumped, from the carbon dioxide tank, 149, by the supplementary atomizing gas compressor, 150, into the lower portion of the contactor chamber, 142, but above the fluid level, 147, therein. The carbon dioxide supplementary atomizing gas flows upward, through the packing material, 151, in the contactor chamber, countercurrent to the downward flow of slurry fuel. Much of the carbon dioxide will become dissolved into the continuous water phase of the slurry fuel. Undissolveable gas impurities and a small portion of carbon dioxide will leave the top of the contactor chamber, 142, via the small flow area gas bleed nozzle, 152.
(6) A high and essentially constant pressure is maintained within the contactor chamber, 142, and the slurry fuel common rail, 143, by the controller, 152, of the supplementary atomizing gas compressor, 150, responsive to the pressure sensor, 153, of contactor chamber pressure. Gas compressor intercoolers, and a final gas cooler, 154, can be used to maintain a low temperature of the carbon dioxide gas going in to the contactor chamber, in order to improve gas solubility into the continuous water phase of the slurry fuel. Contactor chamber and common rail pressure is to be essentially equal to fuel injection pressure.
(7) Slurry fuel injection into each engine combustion chamber starts when the fuel injection valve is opened by the electronic timer unit, 137, and ends when the fuel shut off valve is closed by the electronic timer unit, 137.

### Diagram of Fuel Injector Piping

The interconnections between the double valves of the fuel injector, the separate pressure and vent valves and operators, and the timing units are summarized diagrammatically in FIG. 8. The fuel injection valve timer, 67, rotated by the engine crankshaft, 52, or camshaft, 28, sends an opening power pulse to the operator of the fuel injection valve, 2, pressure and vent valve, 25, to connect high pressure hydraulic fluid from the hydraulic fluid common rail, 68, to the piston, cylinder, and spring driver, 1, of the fuel injection valve, 2, via pipe, 69, and the fuel injection valve is opened. Subsequently the timer, 67, sends a closing power pulse to the operator of the fuel injection valve pressure and vent valve, 25, to connect vented hydraulic fluid into the hydraulic fluid tank, 70, via the same pipe, 69, and the fuel injection valve is closed.

Similarly the fuel shut off valve timer, 71, rotated by the engine crankshaft, 52, or camshaft, 28, sends an opening power pulse to the operator of the fuel shut off valve, pressure and vent valve, 72, and connect high pressure hydraulic fluid from the hydraulic fluid common rail, 68, to the piston, cylinder and spring driver, 4, of the fuel shut off valve, 5, via pipe, 73, and the fuel shut off valve is opened. Subsequently the timer, 71, sends a closing power pulse to the operator of the fuel shut off valve pressure and vent valve, 72, to connect vented hydraulic fluid into the hydraulic fluid tank, 70, via the same pipe, 73, and the fuel shut off valve is closed.

High pressure hydraulic fluid is resupplied into the hydraulic fluid common rail, 68, from the hydraulic fluid tank, 70, by the high pressure hydraulic fluid pump, 74.

For the mechanical timer shown in FIG. 2, and described hereinabove, the mechanical pressure and vent valves, 25, 72, are integral with the cam timers, 67, 71, so that the pipes, 69, 73, run from the timers on the crankshaft or camshaft to each fuel injector on each engine combustion chamber.

For the electrical timer shown in FIG. 5, and described hereinabove, the solenoid operated pressure and vent valves are integral with each fuel injector on each engine combustion chamber, so that the power pulses from the timer units, 67, 71, are delivered, via electric power cables, 75, 76, to the pressure and vent valves, 25, 72.

### Engine Combustion Benefits

When a slurry fuel, containing supplementary atomizing gas dissolved thereinto at high contactor chamber pressure, is injected into a diesel engine combustion chamber, final atomizing occurs in two steps. The high velocity slurry fuel jet is atomized by aerodynamic forces into primary fuel droplets. These primary slurry fuel droplets are then broken apart by expansion of the supplementary atomizing gas out of solution from the continuous phase at the much lower pressures in the engine combustion chamber. The originally preatomized, and very small, fuel particles thus emerge fully separated and can undergo rapid and efficient combustion in the engine combustion chamber. In this way high viscosity residual fuels, and tars such as from the Athabaska tar sands, can be efficiently used in small and medium bore, moderate and high speed, diesel engines, as are widely used in our transportation, farming, and mining industries. This is a principal beneficial object of this invention.

### Industrial Uses of the Invention

Several combinations of preatomized fuel particles, suspended in a continuous phase containing dissolved supplementary atomizing gas, can be efficiently used as fuel for small and medium bore diesel engines, operated at high to medium speed, by use of the slurry fuel injection systems of this invention. The following examples illustrate several of these slurry fuel combinations.
(1) Residual petroleum fuel particles, suspended in a continuous water phase, with a small portion of high cetane number distillate petroleum igniter fuel particles, and using carbon dioxide, or air, or diesel engine exhaust, or oxygen as supplementary atomizing gas;
(2) Tar fuel particles from Athabaska tar sands, suspended in a continuous water phase, with a small portion of high cetane number distillate petroleum igniter fuel particles, and using carbon dioxide, or air, or diesel engine exhaust, or oxygen as supplementary atomizing gas;
(3) Coal tar fuel particles from coke ovens, suspended in a continuous water phase, with a small portion of high cetane number distillate petroleum igniter fuel particles, and using carbon dioxide, or air, or diesel engine exhaust, or oxygen as supplementary atomizing gas;
(4) Biomass tar fuel particles from the destructive distillation of non food farm harvest biomass material, suspended in a continuous water phase, with a small portion of high cetane number distillate petroleum igniter fuel particles, and using carbon dioxide, or air, or diesel engine exhaust, or oxygen as supplementary atomizing gas;
(5) Finely shredded non food farm harvest biomass particles suspended in a continuous distillate petroleum fuel phase, such as number two diesel fuel; and using methane, or natural gas, as supplementary atomizing gas;

Some risk of explosion, internal to the slurry fuel common rail, the contactor chamber, and the fuel injectors, may exist when using supplementary atomizing gas containing oxygen, such as air, and particularly when using moderate purity oxygen gas.

Apparatus for preparing several of these slurry fuels is described in my following US Patent applications, now on file in the US Patent and Trademark Office:
(a) U.S. patent application Ser. No. 11/796,714, entitled, Rotary Residual Fuel Slurrifier, filed 30 Apr. 2007.
(b) U.S. patent application Ser. No. 12/583,448, entitled Rotary Tar Slurrifier, filed 21 Aug. 2009.
(c) U.S. patent application Ser. No. 12/454,640, entitled, Engine Fuels From Coal Volatile Matter, filed 21 May 2009.
(d) U.S. patent application Ser. No. 12/590,333, entitled Cyclic Batch Coal Devolatilization Apparatus, filed 6 Nov. 2009.
(e) U.S. patent application Ser. No. 12/653,189, entitled Engine Fuels From Coal and Biomass Volatile Matter, filed 10 Dec. 2009.

This material is incorporated herein by reference thereto.

The residual fuel content of newly discovered crude oils has tended to increase with the passage of time. Indeed some large new oilfields, such as the Athabaska tar sands, yield a crude oil which is essentially wholly residual fuel. Distillate petroleum fuels can be prepared from these residual and tar fuels, but substantial fuel and energy losses result. Direct use of residual fuels in transportation engines is now confined to large bore, slow speed marine diesel engines. All other transportation engines currently require use of expensive distillate petroleum fuels, which are increasingly in reduced supply.

Preatomization of residual fuels, tars from tar sands, and tars from coal and biomass, into a suspension of very small fuel particles in a continuous water phase, is a promising method for efficiently using these fuels in small and medium bore, high and medium speed, diesel engines, which are the major power source for our critical transportation industry. A major step toward the energy independence needed for a sound national defense can be achieved in this way.

Having thus described my invention, what I claim is:

1. A combined double valve slurry fuel injector for injecting slurry fuels, containing supplementary atomizing gas dissolved into the continuous phase of the slurry, into the combustion chamber of a diesel engine; and comprising
a source of high pressure hydraulic fluid, and a receiver of low pressure hydraulic fluid;
a source of high pressure slurry fuel comprising fuel particles suspended in a continuous liquid phase;
wherein each said double fuel valves fuel injector comprises a fuel injector body with a fuel injection nozzle, a fuel injection valve for admitting fuel flow to said fuel injection nozzle when open, and for stopping fuel flow to said fuel injection nozzle when closed, a fuel shut off valve for admitting fuel flow to said fuel injection valve when open, and for stopping fuel flow to said fuel injection valve when closed;
said fuel injection valve comprising a fixed valve seat on the fuel injection body, a moveable valve seat on a fuel injection valve head, said fuel injection valve head being secured to one end of a moveable fuel injection valve shaft, said fuel injection valve being closed whenever said fixed valve seat and said moveable valve seat are forced together by said fuel injection valve shaft, and being open whenever said fixed valve seat and said moveable valve seat are pulled apart by said fuel injection valve shaft;
said fuel shut off valve comprising a moveable valve seat on the fuel injector valve head, and another moveable valve seat on a fuel shut off valve shaft, said fuel shut off valve shaft being sealably operable within said fuel injector body, and said fuel injection valve shaft being sealably operable within said fuel shut off valve shaft;
wherein the two separate moveable valve seats on the fuel injection valve head have a common outer radius; and the outer radius of the fuel shut off valve shaft is greater than the common outer radius of the two separate moveable valve seats on the fuel injection valve head, in order to create a fuel flow path past the common outer radius of the two valve seats on the fuel injection valve head;
wherein an intershaft fuel flow passage exists between the lower portion of the fuel shut off valve shaft and the lower portion of the fuel injection valve shaft and the head thereof;
said fuel injector body further comprising a slurry fuel connector and a fuel flow passage from said connector to a fuel manifold surrounding a portion of said fuel shut off valve shaft;
wherein said fuel shut off valve shaft comprises one or more fuel passages between said intershaft fuel flow passage and said fuel manifold and said fuel manifold is sufficiently wide in the direction of motion of said fuel shut off valve shaft, that a fuel flow connection always exists between said fuel manifold and said intershaft fuel flow passage via said one or more fuel passages;
whereby a fuel flow path is created so that: whenever both the fuel injector valve and the fuel shut off valve are open between their seats, fuel can flow from said slurry fuel connector, into said intershaft fuel flow passage, via said fuel manifold, and from said intershaft fuel flow passage into said fuel injection nozzle and the engine combustion chamber, via said open fuel shut off valve, followed by said open fuel injection valve; and further so that whenever the fuel shut off valve is closed between its two moveable seats, fuel cannot flow from said slurry fuel connector via said fuel flow path, into said fuel injection nozzle and the engine combustion chamber;
each double valve slurry fuel injector further comprising, piston, cylinder, and spring slurry fuel injection valve driver means for opening and closing said fuel injection valve, via said slurry fuel injection valve shaft, wherein said driver piston is secured to said fuel injector valve shaft, and said driver spring acts on the vented closing side of said driver piston to close said fuel injection valve, and high pressure hydraulic fluid, from said source of high pressure hydraulic fluid, can act on the opposite, opening side of said driver piston to open said fuel injection valve, said high pressure hydraulic fluid being admitted into the opening side of said driver piston, from said source of high pressure hydraulic fluid, via a fuel injection valve pressure and vent valve, with pressure and vent connections and an operator, so that when said fuel injection valve pressure and vent valve is open to the pressure connection, high pressure hydraulic fluid can flow onto the opening side of said driver piston to open said fuel injection valve, and when said fuel injection valve pressure and vent valve is open to the vent connection, hydraulic fluid can be forced out of the pressure side of said driver piston by said spring, to close said fuel injection valve, and to return said hydraulic fluid to said receiver of low pressure hydraulic fluid;
each double valve slurry fuel injector further comprising piston, cylinder, and spring slurry fuel shut off valve driver means for opening and closing said fuel shut off valve, via said slurry fuel shut off valve shaft, wherein said driver piston is secured to said slurry fuel shut off valve shaft, and said driver spring acts on the vented closing side of said driver piston to close said fuel shut off valve, and high pressure hydraulic fluid, from said source of hydraulic fluid, can act on the opposite opening side of said driver piston to open said fuel shut off valve, said high pressure hydraulic fluid being admitted into the opening side of said driver piston, from said source of high pressure hydraulic fluid, via a slurry fuel shut off valve, pressure and vent valve, with pressure and vent connections and an operator, so that, when said fuel shut off valve pressure and vent valve is open to the pressure connection, high pressure hydraulic fluid can flow onto the opening side of said driver piston to open said fuel shut off valve, and when said fuel shut off valve pressure and vent valve is open to the vent connection, hydraulic fluid can be forced out of the pressure side of said driver piston, by said spring, to close said fuel shut off valve;
wherein the net opening force created by said piston, cylinder, and spring driver of said slurry fuel injection valve, is greater than the net closing force created by said piston, cylinder, and spring driver of said slurry fuel shut off valve;
wherein the operator of said fuel injection valve driver pressure and vent valve is one chosen from the group of pressure and vent valve operators consisting of: mechanical cam and return spring operators; solenoid opener and separate solenoid closer operators; solenoid opener and spring closer operators; piezoelectric opener and closer operators;
wherein the operator of said fuel shut off valve driver pressure and vent valve is one chosen from the group of pressure and vent valve operators consisting of: mechanical cam and return spring operators; solenoid opener and separate solenoid closer operators; solenoid opener and spring closer operators; piezoelectric opener and closer operators.

2. A number of separate combined double valve slurry fuel injectors, as described in claim 1, in combination with a diesel engine:
wherein said diesel engine comprises an integral number of separate piston and cylinder units, each of which compressibly enclose a combustion chamber, said pistons being reciprocated within said cylinders by an engine crankshaft, each said diesel engine which operates on a four piston strokes cycle additionally comprising a camshaft;
said number of separate combined double valve slurry fuel injectors being another integral multiple of said number of diesel engine piston and cylinder units, with each combustion chamber being fitted with the same number of separate combined double valve slurry fuel injectors;
said combination further comprising a source of supplementary atomizing gas at least some portions of which are soluble in said continuous phase of said slurry fuel;
said diesel engine further comprising a high pressure slurry fuel common rail system comprising: a high pressure slurry fuel common rail with high pressure slurry fuel connections to each said slurry fuel connector of each said slurry fuel injector; a contactor chamber for contacting supplementary atomizing gas with slurry fuel so that at least some portions of said supplementary atomizing gas are dissolved at high pressure into the continuous phase of the slurry fuel; a high pressure engine driven slurry fuel pump for transferring slurry fuel, from said slurry fuel source into said contactor chamber at high contactor chamber pressure; means for transferring supplementary atomizing gas, from said source of high pressure supplementary atomizing gas, into said contactor chamber at high pressure; means for transferring slurry fuel, containing dissolved supplementary atomizing gas, from said contactor chamber into said common rail without a decrease of pressure; said high pressure in said slurry fuel common rail being essentially equal to the maximum pressure of fuel injection into said diesel engine combustion chamber; said high pressure in said contactor chamber being appreciably greater than the maximum pressure reached in said diesel engine combustion chamber, but no greater than the high pressure in said slurry fuel common rail;
said diesel engine further comprising a high pressure hydraulic fluid common rail system comprising:
a hydraulic fluid common rail; an engine driven hydraulic fluid pump for transferring hydraulic fluid, from said hydraulic fluid source, and pumping it at high pressure into said hydraulic fluid common rail; high pressure hydraulic fluid connections, from said hydraulic fluid common rail, to each said fuel injection valve pressure and vent valve pressure connection and to each said fuel shut off valve pressure and vent valve pressure connection, of each said double valve slurry fuel injector; wherein said high pressure in said hydraulic fluid common rail is sufficient in combination with the pistons and springs of the driver means of said fuel injection valves and said fuel shut off valves to open said combined double valves in each said slurry fuel injector;
wherein said receiver of hydraulic fluid is said hydraulic fluid source and further comprises low pressure hydraulic fluid connections to each said fuel injection valve pressure and vent valve vent connection, and to each said fuel shut off valve pressure and vent valve vent connection, of each said double valve slurry fuel injector, so that hydraulic fluid released from said opening side of said driver pistons, during closure of said fuel injection valve, and during closure of said fuel shut off valve, is returned to said hydraulic fluid source;
wherein said diesel engine further comprises: a crankshaft for a two stroke cycle engine, and both a crankshaft and a camshaft for a four stroke cycle engine; timer means for separately operating said fuel injection valve pressure and vent valve, and said fuel shut off valve pressure and vent valve, so that:
the slurry fuel shut off valve is opened before the slurry fuel injection valve is opened;
the slurry fuel injection valve is opened at or near to best fuel efficiency timing for the diesel engine cycle;
the slurry fuel shut off valve is adjustably closed before the slurry fuel injection valve, to control the quantity of slurry fuel injected per diesel engine cycle, in order to control engine torque;
the slurry fuel injection valve is closed after the closing of the slurry fuel shut off valve;
said timer means being operated and timed by the crankshaft of said diesel engine for two stroke cycle diesel engines, and being operated and timed by the camshaft of said diesel engine for four stroke cycle diesel engines, said timer means being one selected from the group of timer means consisting of the following:
(1) rotating cams to separately mechanically operate mechanical pressure and vent valves of said fuel injection valves, and separate mechanical pressure and vent valves of said fuel shut off valves;
(2) a timed electric power generator to separately energize solenoid operated pressure and vent valves of said fuel injection valves, and solenoid operated pressure and vent valves of said fuel shut off valves;
(3) a timed electric power generator to separately energize piezoelectric operated pressure and vent valves of said fuel injection valves, and said piezoelectric operated pressure and vent valves of said fuel shut off valves;
(4) a timed electronic power generator to separately energize solenoid operated pressure and vent valves of said fuel injection valves, and said solenoid operated pressure and vent valves of said fuel shut off valves.
(5) a timed electronic power generator to separately energize piezoelectric operated pressure and vent valves of said fuel injection valves, and said piezoelectric operated pressure and vent valves of said fuel shut off valves;
(6) a timed electric power generator to separately energize solenoid and spring operated pressure and vent valves of said fuel injection valves, and solenoid and spring operated pressure and vent valves of said fuel shut off valves;
whereby essentially the only slurry fuel being depressurized, during each slurry fuel injection, is that injected into the engine combustion chamber, where this depressurization created needed supplementary atomization, and only trace quantities of depressurized fuel are left behind in the fuel injector, and further whereby slurry fuel is not used for driving the fuel injection system, and compressed supplementary atomizing gas is not lost in this operation.

3. A slurry fuel injection system as described in claim 2, wherein: said slurry fuel common rail comprises: a common rail; a slurry fuel common rail pump and driver; control means for controlling said slurry fuel common rail pump, so that slurry fuel common rail pressure is maintained within the slurry fuel common rail by pumping fluid, from the inlet of said common rail pump, into said common rail;
and further comprising:
a slurry fuel contactor chamber for contacting slurry fuel with atomizing gas at contactor chamber pressure, and comprising an upper portion and a lower portion, these portions being flow connected together;
contactor chamber slurry fuel pump and driver means for transferring slurry fuel, from said slurry fuel source into said contactor chamber, at contactor chamber pressure and into the upper portion of said contactor chamber;
atomizing gas transfer means for transferring atomizing gas, from said source of high pressure atomizing gas into said slurry fuel contactor chamber, at contactor chamber pressure, and into the lower portion of said contactor chamber, well below the level at which slurry fuel is transferred into said contactor chamber;
slurry transfer means for transferring slurry fuel from the lower portion of said contactor chamber, into the inlet of said slurry fuel common rail pump;
slurry fuel level sensor means for sensing the level of slurry fuel within said contactor chamber;
contactor chamber slurry fuel pump and driver control means for controlling the rate of transfer of slurry fuel, from said source of slurry fuel, into said slurry fuel contactor chamber, responsive to said slurry fuel level sensor, and operative to; keep the lower portion of said contactor chamber full of slurry fuel, and, keep the level of slurry fuel below the upper portion of said contactor chamber;
wherein said slurry level sensor means, and said contactor chamber slurry fuel pump and driver control means, can be any one of the operations; hand sensor and control means; automatic sensor and control means, and, a combination of hand and automatic sensor and control means;
whereby slurry fuel flows from said source of slurry fuel, into and downward through said contactor chamber, and into said inlet of said common rail pump, and into said slurry fuel common rail to be delivered therefrom into each said slurry fuel injector;
a sensor of contactor chamber pressure;
a sensor and controller of flow rate of atomizing gas into said contactor chamber; and a sensor and controller of flow rate of atomizing gas out of said contactor chamber;
contactor chamber pressure control means for maintaining the gas pressure in said contactor chamber essentially constant about an average contactor chamber pressure responsive to said sensor of contactor chamber pressure, and operative to adjust the difference quantity of, the flow rate of atomizing gas into said contactor chamber, minus the flow rate of atomizing gas out of said contactor chamber, increasing said difference quantity when sensed contactor chamber pressure falls below said average contactor chamber pressure, and decreasing said difference quantity when said average contactor chamber pressure is greater than said average contactor chamber pressure;
wherein said average slurry fuel contactor chamber pressure is less than, said common rail pressure, and is greater than, and preferably appreciably greater than, the maximum pressure prevailing in said combustion chamber, of said diesel engine,
wherein said slurry fuel common rail pressure is controlled to be sufficiently greater than the pressures prevailing in said engine combustion chambers as to assure adequate slurry fuel primary atomization, into slurry droplets, when injected into said engine combustion chambers;
wherein said slurry fuel contactor chamber pressure and gas flow rate sensor, and control means can be any one of the options; hand sensor and control means; automatic sensor and control means; and a combination of hand and automatic sensor and control means;
wherein each said double valve slurry fuel injector further comprises a spring loaded piston and cylinder slurry fuel hydraulic accumulator for minimizing slurry fuel pressure variations during slurry fuel injection, said slurry fuel hydraulic accumulator being connected to said slurry fuel supply connector in common with said slurry fuel flow connection thereto from said slurry fuel common rail;
whereby atomizing gas flows, from said source of atomizing gas, into said contactor chamber, countercurrent to said downward flow of slurry fuel therein and at least portions of said atomizing gas are dissolved into the continuous phase portion of said slurry fuel; and said dissolved portions of atomizing gas flow, with said slurry fuel, into the common rail of said common rail fuel injection system; and are injected with said slurry fuel into the combustion chamber of said diesel engine, where, at the lower pressures prevailing in said cylinder gas volume; said dissolved atomizing gas expands out of solution from said continuous phase portion, and separates the fuel particles, within each slurry fuel droplet, into separated fuel particles, thus increasing the fuel surface area available for fuel burning, and hence the rate and completeness of fuel combustion within each cylinder gas volume.

4. A slurry fuel injection system as described in claim 2 wherein said high pressure slurry fuel common rail comprises:
a contactor chamber for contacting slurry fuel with atomizing gas and comprising an upper portion and a lower portion, these portions being flow connected together;
a common rail distribution system for delivering slurry fuel into each said slurry fuel injector, said common rail being free flow connected to the bottom of the lower portion of said contactor chamber;
slurry fuel pump and driver means for transferring slurry fuel, from said source of slurry fuel, into said contactor chamber, and comprising a slurry fuel flow divider for dividing said transferring slurry fuel into two separate flows of slurry fuel, one said separate flow of slurry fuel being transferred into said upper portion of said contactor chamber, the other said separate flow of slurry fuel being transferred into said lower portion of said contactor chamber;
slurry fuel level sensor means for sensing the level of slurry fuel within said contactor chamber;
slurry fuel pump and driver control means for controlling the rate of transfer of slurry fuel, from said source of slurry fuel, into said contactor chamber, responsive to said slurry fuel level sensor; and operative to; keep the lower portion of said contactor chamber full of slurry fuel, and, keep the level of slurry fuel below the upper portion of said contactor chamber;
wherein said slurry level sensor means, and said slurry pump and driver control means, can be any one of the options: hand sensor and control means; automatic sensor and control means; and, a combination of hand and automatic sensor and control means;
whereby slurry fuel flows, from said source of slurry fuel, into said contactor chamber, in two separate flows, that one separate flow into the upper portion of said contactor chamber flowing downward through said contactor chamber to rejoin, and blend with that other separate flow into the lower portion of said contactor chamber, and this combined slurry fuel flows into said common rail distribution system, and is delivered therefrom into each said slurry fuel injector;
atomizing gas transfer means for transferring atomizing gas, from said source of high pressure atomizing gas, into said contactor chamber, at a level within said contactor chamber, well below the level at which one said separate flow of slurry fuel is transferred into said upper portion of said contactor chamber, and at a level within said contactor chamber above the level at which said other separate flow of slurry fuel is transferred into said lower portion of said contactor chamber;
contactor chamber pressure sensor and control means for maintaining the gas pressure, in said upper portion of said contactor chamber, essentially constant, about an average contactor chamber pressure, less than an upper set value of contactor chamber gas pressure, and greater than a lower set value of contactor chamber gas pressure, said control means being responsive to said contactor chamber pressure sensor, and operative to adjust the difference quantity of, the flow rate of atomizing gas into said contactor chamber, minus the flow rate of atomizing gas in gaseous form out of said contactor chamber, increasing said difference quantity when said sensed contactor pressure is less than said lower set value, and decreasing said difference quantity when said sensed contactor chamber pressure is greater than said upper set value;
wherein said average contactor chamber pressure is controlled to be sufficiently greater than the pressures prevailing in said engine combustion chamber of said internal combustion engine, as to assure adequate slurry fuel primary atomization into droplets when injected into said engine combustion chamber;
wherein said contactor chamber pressure sensor and control means can be any one of the options; hand sensor and control means; automatic sensor and control means; and a combination of hand and automatic sensor and control means;
and further wherein the pressure prevailing, within said slurry fuel common rail distribution system, is essentially the same as said contactor chamber pressure;
whereby atomizing gas flows, from said source of atomizing gas, into said contactor chamber, countercurrent to said downward flow of said one separate flow of slurry fuel, which was transferred into said upper portion of said contactor chamber, and at least portions of said atomizing gas are dissolved into the continuous phase portion of that one separate flow of slurry fuel, and this one separate flow of slurry fuel becomes at least partially saturated with soluble portions of said atomizing gas;
and further whereby said one separate flow of slurry fuel, transferred into the upper portion of said contactor chamber, and becoming at least partially saturated with atomizing gas therein, is subsequently blended with that other separate flow of slurry fuel, transferred into the lower portion of said contactor chamber, and not contacted with atomizing gas, and this recombined flow of slurry fuel into slurry fuel common rail is less than saturated with atomizing gas;
and further whereby said recombined flow of slurry fuel, with dissolved portions of atomizing gas, flows into said common rail distribution system, and is injected into the combustion chambers of said piston internal combustion engine, where, at the lower pressures prevailing in said cylinder gas volume, said dissolved atomizing gas expands out of solution from the continuous phase portion of said slurry fuel, and separates the fuel particles, within each slurry droplet, into separated fuel particles, thus increasing the fuel surface available for fuel burning, and hence the rate and completeness of fuel combustion within each cylinder gas volume of said piston internal combustion engine;
wherein each said double valve slurry fuel injector further comprises a spring loaded piston and cylinder slurry fuel hydraulic accumulator for minimizing slurry fuel pressure variations during slurry fuel injection, said slurry fuel hydraulic accumulator being connected to said slurry fuel supply connector in common with said slurry fuel flow connection thereto from said slurry fuel common rail.

5. A slurry fuel injection system as described in claim 2, wherein said high pressure slurry fuel common rail comprises:
a contactor chamber for contacting slurry fuel with atomizing gas, and comprising an upper portion and a lower portion, these portions being flow connected together;
a common rail distribution system for delivering slurry fuel into each said slurry fuel injector, said common rail being free flow connected to the bottom of the lower portion of said contactor chamber;
slurry fuel pump and driver means for transferring slurry fuel, from said source of slurry fuel, into said contactor chamber, and into said upper portion of said contactor chamber;
slurry fuel level sensor means for sensing the level of slurry fuel within said contactor chamber;
slurry fuel pump and driver control means for controlling the rate of transfer of slurry fuel, from said source of slurry fuel, into said contactor chamber, responsive to said slurry fuel level sensor, and operative to; keep the lower portion of said contactor chamber full of slurry fuel, and, keep the level of slurry fuel below the upper portion of said contactor chamber;
wherein said slurry fuel sensor means, and said slurry pump and driver control means, can be any one of the options: hand sensor and control means, automatic sensor and control means; and, a combination of hand and automatic sensor and control means;
whereby slurry fuel flows downward through said contactor chamber into said lower portion thereof and into said common rail distribution system;
atomizing gas transfer means for transferring atomizing gas, from said source of high pressure atomizing gas, into said contactor chamber, and into the bottom of the lower portion of said contactor chamber, and thus below the level of slurry fuel within said contactor chamber;
contactor chamber pressure sensor and control means for maintaining the gas pressure, in said upper portion of said contactor chamber, essentially constant about an average contactor chamber pressure, less than an upper set value of contactor chamber pressure, and greater than a lower set value of contactor chamber pressure;
said contactor chamber pressure controller means being one selected from the group of pressure control means consisting of the following:
(1) a back pressure control valve for adjusting the flow area of a flow restrictor, through which undissolved atomizing gas is discharged from said contactor chamber into the atmosphere, responsive to said pressure sensor, and operative to increase restrictor flow area when contactor chamber pressure exceeds said upper set valve, and to decrease restrictor flow area when contactor chamber pressure is less than said lower set value;
(2) a work recovery engine through which undissolved atomizing gas is discharged from said contactor chamber into the atmosphere, and comprising a gas flow rate control means, responsive to said contactor chamber pressure sensor, and operative to increase gas flow rate into said work recovery engine when contactor chamber pressure exceeds said upper set value, and to decrease gas flow rate into said work recovery engine when contactor chamber pressure is less than said lower set value;
wherein said average contactor chamber pressure is controlled to be sufficiently greater than the pressures prevailing in said engine combustion chamber, as to assure adequate slurry fuel primary atomization into slurry droplets when injected into said cylinder gas volumes;
wherein said contactor chamber pressure sensor and control means can be any one of the options: hand sensor and control means; automatic sensor and control means; and a combination of hand and automatic sensor and control means;
and further wherein the pressure prevailing within said common rail distribution system, is essentially the same as said contactor chamber pressure, and is essentially fully applied along essentially the full length of the slurry fuel flow path within said common rail distribution system;
whereby atomizing gas flows, from said source of atomizing gas, into said contactor chamber below the level of slurry fuel therein, and rises, as bubbles, countercurrent to the downward flow of slurry fuel therethrough, and portions of said atomizing gas are dissolved into the continuous phase of said slurry fuel, which becomes partially saturated with soluble portions of said atomizing gas;
and further whereby said flow of slurry fuel, with dissolved portions of atomizing gas, flows into said common rail distribution system, and is injected into the combustion chambers of said diesel engine, where, at the lower pressures prevailing in said cylinder gas volume, said dissolved atomizing gas expands out of solution from the continuous phase portion of said slurry fuel, and separates the fuel particles, within each slurry droplet, into separated fuel particles, thus increasing the fuel surface available for fuel burning, and hence the rate and completedness of fuel combustion within each cylinder gas volume of said piston internal combustion engine.

6. A slurry fuel injection system as described in claim 2:
wherein said pressure and vent valves, operating each driver of said slurry fuel injection valve, are driven and timed by a fuel injection valve cam with spring return driver;
wherein said pressure and vent valves operating each driver of said slurry fuel shut off valve, are driven and timed by a fuel shut off valve cam with spring return driver;
wherein said fuel injection valve cam is driven and timed by the crankshaft of a two stroke cycle diesel engine and by the camshaft of a four stroke cycle diesel engine, so that slurry fuel injection into the diesel engine combustion chamber occurs at or near to best diesel engine cycle efficiency timing, and in at least one or more than one separate fuel injection pulses;
wherein the cam arc of opening of said fuel shut off valve cam is greater than the cam arc of opening of said fuel injection valve cam;
wherein said fuel shut off valve cam is driven and timed from the crankshaft of a two stroke cycle diesel engine, and from the camshaft of a four stroke cycle diesel engine, via an adjustable angular phase change unit, such as a moveable helical spline sleeve meshing with an engine shaft driven helical gear, so that the timing of the slurry fuel shut off valve can be adjusted, relative to the timing of the slurry fuel injection valve, by moving said adjustable helical spline sleeve, relative to said helical gear portion of said cam driver shaft;
wherein said slurry fuel shut off valve is timed relative to said fuel injection valve so that:
said slurry fuel shut off valve is opened before said slurry fuel injection valve is opened;
said slurry fuel shut off valve is adjustably closed before said slurry fuel injection valve is closed, so that the duration of slurry fuel injection, and hence the quantity of slurry fuel injected into each diesel engine cycle, can be adjusted by adjusting said helical sleeve, in order to adjust diesel engine torque.

7. A slurry fuel injection system as described in claim 2, wherein:
said pressure and vent valves, operating each driver of said fuel injection valve, are driven by valve opening solenoid drivers and by valve closing solenoid drivers;
said pressure and vent valves, operating each driver of said fuel shut off valve, are driven by valve opening solenoid drivers and by valve closing solenoid drivers;
wherein said fuel injection timing means comprises a timed electric power generator to energize said solenoid drivers and comprising a fuel injection valve timing means, and a separate fuel shut off valve timing means;
and further comprising an electric power source such as an electric power generator in combination with a battery;
wherein each said fuel injection valve timing means comprises:
(a) a solenoid and spring operated, double position, electric switch, for connecting said electric power source to said valve opening solenoid driver of said fuel injection valve pressure and vent valve, when the solenoid of said double position electric switch is energized, and for connecting said electric power source to said valve closing solenoid driver of said fuel injection valve pressure and vent valve, when the solenoid of said double position electric switch is not energized;
(b) a fuel injection valve rotating shutter timer disc, rotated by the engine crankshaft for two stroke cycle diesel engines, and rotated by the engine camshaft for four stroke cycle diesel engines, and comprising at least one shutter opening, and all of said shutter openings being at the same radius;
(c) a photocell and electric light generator of electric power pulses, aligned to said fuel injection valve rotating shutter timer disc, so that light from said electric light reaches said photocell only when said timed shutter openings cross the light path from said electric light to said photocell to generate an electric power pulse, said electric power pulse being connected to said solenoid of said double position electric switch, so that, whenever said timed shutter openings are aligned to said light path, an electric power pulse from said electric power source energizes said valve opening solenoid drivers on pressure and vent valves of said fuel injection valve, and said fuel injection valve is open and fuel injection into the engine combustion chamber starts, and so that whenever said timed shutter openings are not aligned to said light path, an electric power pulse from said electric power source energizes said valve closing solenoid drivers on pressure and vent valves of said fuel injection valve, and said fuel injection valve is closed;
(d) said photocell and electric light being on a common bracket, which is angularly adjustable about the rotational centerline of said fuel injection valve rotating shutter disc, in order to adjust the time of starting said injection of fuel into said engine combustion chamber to be at best efficiency timing for the diesel engine cycle;
(e) wherein for a multicylinder diesel engine, all fuel injection valves can be served by a common fuel injection valve rotating shutter timer disc;
wherein each said fuel shut off valve timing means comprises:
(f) a solenoid and spring operated, double position, electric switch, for connecting said electric power source to said valve opening solenoid driver of said fuel shut off valve, when the solenoid of said double position electric switch is energized, and for connecting said electric power source to said valve closing solenoid driver of said fuel shut off valve, when the solenoid of said double position electric switch is not energized;
(g) a fuel shut off valve rotating shutter timer disc, rotated by the engine crankshaft for two stroke cycle diesel engines, and rotated by the engine camshaft for four stroke cycle diesel engines, and comprising the same number of shutter openings, and the same angular spacing of shutter openings, as said fuel injection valve rotating shutter timing disc, and all of said shutter openings being at the same radius;
(h) a photocell and electric light generator of electric power pulses, aligned to said fuel shut off valve rotating shutter timer disc, so that light from said electric light
(i) reaches said photocell only when said timed shutter openings cross the light path from said electric light to said photocell to generate an electric power pulse, said electric power pulse being connected to said solenoid of said double position electric switch, so that, whenever said timed shutter openings are aligned to said light path, an electric power pulse from said electric power source energizes said valve opening solenoid drivers of said fuel shut off valve, and said fuel shut off valve is open, and so that whenever said timed shutter openings are not aligned to said light path, an electric power pulse from said electric power source energizes said valve closing solenoid drivers of said fuel shut off valve and said fuel shut off valve is closed;
(j) said photocell and electric light being on a common bracket, which is angularly adjustable about the rotational centerline of said rotating fuel shut off shutter disc in order to adjust the time of closing of the fuel shut off valve and the time of stopping said injection of fuel into said engine combustion chamber;
(k) wherein said shutter openings on said fuel shut off shutter disc are angularly wider than the corresponding shutter openings on said fuel injection shutter disc, so that, said fuel shut off valve is opened before said fuel injection valve is opened, and so that said fuel shut off valve is adjustably closed at some time between the opening of said fuel injection valve and the closing of said fuel injection valve, in order to adjust the duration of fuel injection and thus to adjust the fuel quantity injected per engine cycle, and thus to control engine torque;
wherein for a multicylinder diesel engine, all fuel shut off valves can be served by a common fuel shut off valve rotating shutter timer disc.

8. A slurry fuel injection system as described in claim 2:
wherein the drivers of said pressure and vent valves, operating each fuel injection valve driver, and operating each fuel shut off valve driver, are ones chosen from the group of valve drivers consisting of, solenoid drivers, solenoid and spring drivers, and piezoelectric drivers;
and further comprising an electric power source such as an electric power generator in combination with a battery;
and further comprising a required engine torque input signal;
wherein said fuel injection timing means comprises an electronic generator of timed power pulses which energize said drivers of said pressure and vent valves of each said fuel injection valve, and each said fuel shut off valve; said electronic generator being powered by said electric power source; and being timed by said engine crankshaft for a two stroke cycle diesel engine, and being timed by said engine camshaft for a four stroke cycle diesel engine, so that fuel injection into the diesel engine combustion chamber starts at or near to best diesel engine cycle efficiency timing, and in at least one or more than one separate fuel injection pulses; and further so that fuel injection into the diesel engine combustion chamber can be stopped by said torque input signal, an adjustable time interval following said start of fuel injection in order to adjust fuel flow per engine cycle and thus engine torque.

9. A slurry fuel injection system as described in claim 3:
wherein said pressure and vent valves, operating each driver of said slurry fuel injection valve, are driven and timed by a fuel injection valve cam with spring return driver;
wherein said pressure and vent valves operating each driver of said slurry fuel shut off valve, are driven and timed by a fuel shut off valve cam with spring return driver;
wherein said fuel injection valve cam is driven and timed by the crankshaft of a two stroke cycle diesel engine and by the camshaft of a four stroke cycle diesel engine, so that slurry fuel injection into the diesel engine combustion chamber occurs at or near to best diesel engine cycle efficiency timing, and in at least one or more than one separate fuel injection pulses;
wherein the cam arc of opening of said fuel shut off valve cam is greater than the cam arc of opening of said fuel injection valve cam;
wherein said fuel shut off valve cam is driven and timed from the crankshaft of a two stroke cycle diesel engine, and from the camshaft of a four stroke cycle diesel engine, via an adjustable angular phase change unit, such as a moveable helical spline sleeve meshing with an engine shaft driven helical gear, so that the timing of the slurry shut off valve can be adjusted, relative to the timing of the slurry fuel injection valve, by moving said adjustable helical spline sleeve, relative to said helical gear portion of said cam driver shaft;
wherein said slurry fuel shut off valve is timed relative to said fuel injection valve so that:
said slurry fuel shut off valve is opened before said slurry fuel injection valve is opened;
said slurry fuel shut off valve is adjustably closed before said flurry fuel injection valve is closed, so that the duration of slurry fuel injection, and hence the quantity of slurry fuel injected into each diesel engine cycle, can be adjusted by adjusting said helical sleeve, in order to adjust diesel engine torque.

10. A slurry fuel injection system as described in claim 3, wherein:
said pressure and vent valves, operating each driver of said fuel injection valve, are driven by valve opening solenoid drivers and by valve closing solenoid drivers;
said pressure and vent valves, operating each driver of said fuel shut off valve, are driven by valve opening solenoid drivers and by valve closing solenoid drivers;
wherein said fuel injection timing means comprises a timed electric power generator to energize said solenoid drivers and comprising a fuel injection valve timing means, and a separate fuel shut off valve timing means;
and further comprising an electric power source such as an electric power generator in combination with a battery;
wherein each said fuel injection valve timing means comprises:
(a) a solenoid and spring operated, double position, electric switch, for connecting said electric power source to said valve opening solenoid driver of said fuel injection valve pressure and vent valve, when the solenoid of said double position electric switch is energized, and for connecting said electric power source to said valve closing solenoid driver of said fuel injection valve pressure and vent valve, when the solenoid of said double position electric switch is not energized;
(b) a fuel injection valve rotating shutter timer disc, rotated by the engine crankshaft for two stroke cycle diesel engines, and rotated by the engine camshaft for four stroke cycle diesel engines, and comprising at least one shutter opening, and all of said shutter openings being at the same radius;
(c) a photocell and electric light generator of electric power pulses, aligned to said fuel injection valve rotating shutter timer disc, so that light from said electric light reaches said photocell only when said timed shutter openings cross the light path from said electric light to said photocell to generate an electric power pulse, said electric power pulse being connected to said solenoid of said double position electric switch,
so that, whenever said timed shutter openings are aligned to said light path, an electric power pulse from said electric power source energizes said valve opening solenoid drivers on pressure and vent valves of said fuel injection valve, and said fuel injection valve is open and fuel injection into the engine combustion chamber starts, and so that whenever said timed shutter openings are not aligned to said light path, an electric power pulse from said electric power source energizes said valve closing solenoid drivers on pressure and vent valves of said fuel injection valve, and said fuel injection valve is closed;
(d) said photocell and electric light being on a common bracket, which is angularly adjustable about the rotational centerline of said fuel injection valve rotating shutter disc, in order to adjust the time of starting said injection of fuel into said engine combustion chamber to be at best efficiency timing for the diesel engine cycle;
(e) wherein, for a multicylinder diesel engine, all fuel injection valves can be served by a common fuel injection valve rotating shutter timer disc;
wherein each said fuel shut off valve timing means comprises:
(f) a solenoid and spring operated, double position, electric switch, for connecting said electric power source to said valve opening solenoid driver of said fuel shut off valve, when the solenoid of said double position electric switch is energized, and for connecting said electric power source to said valve closing solenoid driver of said fuel shut off valve, when the solenoid of said double position electric switch is not energized;
(g) a fuel shut off valve rotating shutter timer disc, rotated by the engine crankshaft for two stroke cycle diesel engines, and rotated by the engine camshaft for four stroke cycle diesel engines, and comprising the same number of shutter openings; and the same angular spacing of shutter openings, as said fuel injection valve rotating shutter timing disc, and all of said shutter openings being at the same radius;
(h) a photocell and electric light generator of electric power pulses, aligned to said fuel shut off valve rotating shutter timer disc, so that light from said electric light reaches said photocell only when said timed shutter openings cross the light path from said electric light to said photocell to generate an electric power pulse, said electric power pulse being connected to said solenoid of said double position electric switch, so that whenever said timed shutter openings are aligned to said light path, an electric power pulse from said electric power source energizes said valve opening solenoid drivers of said fuel shut off valve, and said fuel shut off valve is open and so that whenever said timed shutter openings are not aligned to said light path, an electric power pulse from said electric power source energizes said valve closing solenoid drivers of said fuel shut off valve and said fuel shut off valve is closed;
(i) said photocell and electric light being on a common bracket, which is angularly adjustable about the rotational centerline of said rotating fuel shut off shutter disc in order to adjust the time of closing of the fuel shut off valve and the time of stopping said injection of fuel into said engine combustion chamber;
(j) wherein said shutter openings on said fuel shut off shutter disc are angularly wider than the corresponding shutter openings on said fuel injection shutter disc, so that, said fuel shut off valve is opened before said fuel injection vale is opened, and so that said fuel shut off valve is adjustably closed at some time between the opening of said fuel injection valve and the closing of said fuel injection valve, in order to adjust the duration of fuel injection and thus to adjust the fuel quantity injected per engine cycle, and thus to control engine torque;
wherein for a multicylinder diesel engine, all fuel shut off valves can be served by a common fuel shut off valve rotating shutter timer disc.

11. A slurry fuel injection system as described in claim 3:
wherein the drivers of said pressure and vent valves, operating each fuel injection valve driver, and operating each fuel shut off valve driver, are ones chosen from the group of valve drivers consisting of, solenoid drivers, solenoid and spring drivers, and piezoelectric drivers;
and further comprising an electric power source such as an electric power generator in combination with a battery;
and further comprising a required engine torque input signal;
wherein said fuel injection timing means comprises an electronic generator of timed power pulses which energize said drivers of said pressure and vent valves, of each said fuel injection valve, and each said fuel shut off valve; said electronic generator being powered by said electric power source, and being timed by said engine crankshaft for a two stroke cycle diesel engine, and being timed by said engine camshaft for a four stroke cycle diesel engine, so that fuel injection into the diesel engine combustion chamber starts at or near to best diesel engine cycle efficiency timing, and in at least one or more than one separate fuel injection pulses; and further so that fuel injection into the diesel engine combustion chamber can be stopped by said torque input signal, an adjustable time interval following said start of fuel injection in order to adjust fuel flow per engine cycle and thus engine torque.

12. A slurry fuel injection system as described in claim 4:
wherein said pressure and vent valves, operating each driver of said slurry fuel injection valve, are driven and timed by a fuel injection valve cam with spring return driver;
wherein said pressure and vent valves operating each driver of said slurry fuel shut off valve, are driven and timed by a fuel shut off valve cam with spring return driver;
wherein said fuel injection valve cam is driven and timed by the crankshaft of a two stroke cycle diesel engine and by the camshaft of a four stroke cycle diesel engine, so that slurry fuel injection into the diesel engine combustion chamber occurs at or near to best diesel engine cycle efficiency timing, and in at least one or more than one separate fuel injection pulses;
wherein the cam arc of opening of said fuel shut off valve cam is greater than the cam arc of opening of said fuel injection valve cam;
wherein said fuel shut off valve cam is driven and timed from the crankshaft of a two stroke cycle diesel engine, and from the camshaft of a four stroke cycle diesel engine, via an adjustable angular phase change unit, such as a moveable helical spline sleeve meshing with an engine shaft driven helical gear, so that the timing of the slurry fuel shut off valve can be adjusted, relative to the timing of the slurry fuel injection valve, by moving said adjustable helical spline sleeve, relative to said helical gear portion of said cam driver shaft;
wherein said slurry fuel shut off valve is timed relative to said fuel injection valve so that:
said slurry fuel shut off valve is opened before said slurry fuel injection valve is opened;
said slurry fuel shut off valve is adjustably closed before said slurry fuel injection valve is closed, so that the duration of slurry fuel injection, and hence the quantity of slurry fuel injected into each diesel engine cycle, can be adjusted by adjusting said helical sleeve, in order to adjust diesel engine torque.

13. A slurry fuel injection system as described in claim 4, wherein:
said pressure and vent valves, operating each driver of said fuel injection valve, are driven by'valve opening solenoid drivers and by valve closing solenoid drivers;
said pressure and vent valves, operating each driver of said fuel shut off valve, are driven by valve opening solenoid drivers and by valve closing solenoid drivers;
wherein said fuel injection timing means comprises a timed electric power generator to energize said solenoid drivers and comprising a fuel injection valve timing means, and a separate fuel shut off valve timing means;
and further comprising an electric power source such as an electric power generator in combination with a battery;
wherein each said fuel injection valve timing means comprises:
(a) a solenoid and spring operated, double position, electric switch, for connecting said electric power source to said valve opening solenoid driver of said fuel injection valve pressure and vent valve, when the solenoid of said double position electric switch is energized, and for connecting said electric power source to said valve closing solenoid driver of said fuel injection valve pressure and vent valve, when the solenoid of said double position electric switch is not energized;
(b) a fuel injection valve rotating shutter timer disc, rotated by the engine crankshaft for two stroke cycle diesel engines, and rotated by the engine camshaft for four stroke cycle diesel engines, and comprising at least one shutter opening, and all of said shutter openings being at the same radius;
(c) a photocell and electric light generator of electric power pulses, aligned to said fuel injection valve rotating shutter timer disc, so that light from said electric light reaches said photocell only when said timed shutter openings cross the light path from said electric light to said photocell to generate an electric power pulse, said electric power pulse being connected to said solenoid of said double position electric switch,
so that, whenever said timed shutter openings are aligned to said light path, an electric power pulse from said electric power source energizes said valve opening solenoid drivers on pressure and vent valves of said fuel injection valve, and said fuel injection valve is open and fuel injection into the engine combustion chamber starts, and so that whenever said timed shutter openings are not aligned to said light path, an electric power pulse from said electric power source energizes said valve closing solenoid drivers on pressure and vent valves of said fuel injection valve, and said fuel injection valve is closed;
(d) said photocell and electric light being on a common bracket, which is angularly adjustable about the rotational centerline of said fuel injection valve rotating shutter disc, in order to adjust the time of starting said injection of fuel into said engine combustion chamber to be at best efficiency timing for the diesel engine cycle;
(e) wherein, for a multicylinder diesel engine, all fuel injection valves can be served by a common fuel injection valve rotating shutter timer disc;
wherein each said fuel shut off valve timing means comprises:
(f) a solenoid and spring operated, double position, electric switch, for connecting said electric power source to said valve opening solenoid driver of said fuel shut off valve, when the solenoid of said double position electric switch is energized, and for connecting said electric power source to said valve closing solenoid of said fuel shut off valve, when the solenoid of said double position electric switch is not energized;
(g) a fuel shut off valve rotating shutter timer disc, rotated by the engine crankshaft for two stroke cycle diesel engines, and rotated by the engine camshaft for four stroke cycle diesel engines, and comprising the same number of shutter openings, and the same angular spacing of shutter openings, as said fuel injection valve rotating shutter timing disc, and all of said shutter openings being at the same radius;
(h) a photocell and electric light generator of electric power pulses, aligned to said fuel shut off valve rotating shutter timer disc, so that light from said electric light reaches said photocell only when said timed shutter openings cross the light path from said electric light to said photocell to generate an electric power pulse, said electric power pulse being connected to said solenoid of said double position electric switch,
so that, whenever said timed shutter openings are aligned to said light path, an electric power pulse from said electric power source energizes said valve opening solenoid drivers of said fuel shut off valve, and said fuel shut off valve is open, and so that whenever said timed shutter openings are not aligned to said light path, an electric power pulse from said electric power source energizes said valve closing solenoid drivers of said fuel shut off valve and said fuel shut off valve is closed;
(i) said photocell and electric light being on a common bracket, which is angularly adjustable about the rotational centerline of said rotating fuel shut off shutter disc, in order to adjust the time of closing of the fuel shut off valve and the time of stopping said injection of fuel into said engine combustion chamber;
(j) wherein said shutter openings on said fuel shut off shutter disc are angularly wider than the corresponding shutter openings on said fuel injection shutter disc, so that, said fuel shut off valve is opened before said fuel injection valve is opened, and so that said fuel shut off valve is adjustably closed at some time between the opening of said fuel injection valve and the closing of said fuel injection valve, in order to adjust the duration of fuel injection and thus to adjust the fuel quantity injected per engine cycle, and thus to control engine torque;
wherein for a multicylinder diesel engine, all fuel shut off valves can be served by a common fuel shut off valve rotating shutter timer disc.

14. A slurry fuel injection system as described in claim 4:
wherein the drivers of said pressure and vent valves, operating each fuel injection valve driver, and operating each fuel shut off valve driver, are ones chosen from the group of valve drivers consisting of, solenoid drivers, solenoid and spring drivers, and piezoelectric drivers;
and further comprising an electric power source such as an electric power generator in combination with a battery;
and further comprising a required engine torque input signal;
wherein said fuel injection timing means comprises an electronic generator of timed power pulses which energize said drivers of said pressure and vent valves, of each said fuel injection valve, and each said fuel shut off valve; said electronic generator being powered by said electric power source, and being timed by said engine crankshaft for a two stroke cycle diesel engine, and being timed by said engine camshaft for a four stroke cycle diesel engine, so that fuel injection into the diesel engine combustion chamber starts at or near to best diesel engine cycle efficiency timing, and in at least one or more than one separate fuel injection pulses; and further so that fuel injection into the diesel engine combustion chamber can be stopped, by said torque input signal, an adjustable time interval following said start of fuel injection in order to adjust fuel flow per engine cycle and thus engine torque.

15. A slurry fuel injection system as described in claim 5:
wherein said pressure and vent valves, operating each driver of said slurry fuel injection valve, are driven and timed by a fuel injection valve cam with spring return driver;
wherein said pressure and vent valves, operating each driver of said slurry fuel shut off valve, are driven and timed by a fuel shut off valve cam with spring return driver;
wherein said fuel injection valve cam is driven and timed by the crankshaft of a two stroke cycle diesel engine and by the camshaft of a four stroke cycle diesel engine, so that slurry fuel injection into the diesel engine combustion chamber occurs at or near to best diesel engine cycle efficiency timing, and in at least one or more than one separate fuel injection pulses;
wherein the cam arc of opening of said fuel shut off valve cam is greater than the cam arc of opening of said fuel injection valve cam;
wherein said fuel shut off valve cam is driven and timed from the crankshaft of a two stroke cycle diesel engine, and from the camshaft of a four stroke cycle diesel engine, via an adjustable angular phase change unit, such as a moveable helical spline sleeve meshing with an engine shaft driven helical gear, so that the timing of the slurry fuel shut off valve can be adjusted, relative to the timing of the slurry fuel injection valve, by moving said adjustable helical spline sleeve, relative to said helical gear portion of said cam driver shaft;
wherein said slurry fuel shut off valve is timed relative to said fuel injection valve so that:
said slurry fuel shut off valve is opened before said slurry fuel injection valve is opened;
said slurry fuel shut off valve is adjustably closed before said slurry fuel injection valve is closed, so that the duration of slurry fuel injection, and hence the quantity of slurry fuel injected into each diesel engine cycle, can be adjusted by adjusting said helical sleeve, in order to adjust diesel engine torque.

16. A slurry fuel injection system as described in claim 5, wherein:
said pressure and vent valves, operating each driver of said fuel injection valve, are driven by valve opening solenoid drivers and by valve closing solenoid drivers;
said pressure and vent valves, operating each driver of said fuel shut off valve, are driven by valve opening solenoid drivers and by valve closing solenoid drivers;
wherein said fuel injection timing means comprises a timed electric power generator to energize said solenoid drivers and comprising a fuel injection valve timing means, and a separate fuel shut off valve timing means;
and further comprising an electric power source such as an electric power generator in combination with a battery;
wherein each said fuel injection valve timing means comprises:
(a) a solenoid and spring operated, double position, electric switch, for connecting said electric power source to said valve opening solenoid driver of said fuel injection valve pressure and vent valve, when the solenoid of said double position electric switch is energized, and for connecting said electric power source to said valve closing solenoid driver of said fuel injection valve pressure and vent valve, when the solenoid of said double position electric switch is not energized;
(b) a fuel injection valve rotating shutter timer disc, rotated by the engine crankshaft for two stroke cycle diesel engines, and rotated by the engine camshaft for four stroke cycle diesel engines, and comprising at least one shutter opening, and all of said shutter openings being at the same radius;
(c) a photocell and electric light generator of electric power pulses, aligned to said fuel injection valve rotating shutter timer disc, so that light from said electric light reaches said photocell only when said timed shutter openings cross the light path from said electric light to said photocell to generate an electric power pulse, said electric power pulse being connected to said solenoid of said double position electric switch, so that, whenever said timed shutter openings are aligned to said light path, an electric power pulse from said electric power source energizes said valve opening solenoid drivers on pressure and vent valves of said fuel injection valve, and said fuel injection valve is open and fuel injection into the engine combustion chamber starts, and so that whenever said timed shutter openings are not aligned to said light path, an electric power pulse from said electric power source energizes said valve closing solenoid drivers on pressure and vent valves of said fuel injection valve, and said fuel injection valve is closed;
(d) said photocell and electric light being on a common bracket, which is angularly adjustable about the rotational centerline of said fuel injection valve rotating shutter disc, in order to adjust the time of starting said injection of fuel into said engine combustion chamber to be at best efficiency timing for the diesel engine cycle;
(e) wherein for a multicylinder diesel engine, all fuel injection valves can be served by a common fuel injection valve rotating shutter timer disc;
wherein each said fuel shut off valve timing means comprises:
(f) a solenoid and spring operated, double position, electric switch, for connecting said electric power source to said valve opening solenoid driver of said fuel shut off valve, when the solenoid of said double position electric switch is energized, and for connecting said electric power source to said valve closing solenoid of said fuel shut off valve, when the solenoid of said double position electric switch is not energized;
(g) a fuel shut off valve rotating shutter timer disc, rotated by the engine crankshaft for two stroke cycle diesel engines, and rotated by the engine camshaft for four stroke cycle diesel engines, and comprising the same number of shutter openings; and the same angular spacing of shutter openings, as said fuel injection valve rotating shutter timing disc, and all of said shutter openings being at the same radius;
(h) a photocell and electric light generator of electric power pulses, aligned to said fuel shut off valve rotating shutter timer disc, so that light from said electric light reaches said photocell only when said timed shutter openings cross the light path from said electric light to said photocell to generate an electric power pulse, said electric power pulse being connected to said solenoid of said double position from said electric light to said photocell to generate an electric power pulse, said electric power pulse being connected to said solenoid of said double position electric switch, so that whenever said timed shutter openings are aligned to said light path, an electric power pulse from said electric power source energizes said valve opening solenoid drivers of said fuel shut off valve, and said fuel shut off valve is open and so that whenever said timed shutter openings are not aligned to said light path, an electric power pulse from said electric power source energizes said valve closing solenoid drivers of said fuel shut off valve and said fuel shut off valve is closed;
(i) said photocell and electric light being on a common bracket, which is angularly adjustable about the rotational centerline of said rotating fuel shut off shutter disc in order to adjust the time of closing of the fuel shut off valve and the time of stopping said injection of fuel into said engine combustion chamber;
(j) wherein said shutter openings on said fuel shut off shutter disc are angularly wider than the corresponding shutter openings on said fuel injection shutter disc, so that, said fuel shut off valve is opened before said fuel injection valve is opened, and so that said fuel shut off valve is adjustably closed at some time between the opening of said fuel injection valve and the closing of said fuel injection valve, in order to adjust the duration of fuel injection and thus to adjust the fuel quantity injected per engine cycle, and thus to control engine torque;
wherein for a multicylinder diesel engine, all fuel shut off valves can be served by a common fuel shut off valve rotating shutter timer disc.

17. A slurry fuel injection system as described in claim 5:
wherein the drivers of said pressure and vent valves, operating each fuel injection valve driver, and operating each fuel shut off valve driver, are ones chosen from the group of valve drivers consisting of, solenoid drivers, solenoid and spring drivers, and piezoelectric drivers;
and further comprising an electric power source such as an electric power generator in combination with a battery;
and further comprising a required engine torque input signal;
wherein said fuel injection timing means comprises an electronic generator of timed power pulses which energize said drivers of said pressure and vent valves, of each said fuel injection valve, and each said fuel shut off valve; said electronic generator being powered by said electric power source and being timed by said engine crankshaft for a two stroke cycle diesel engine, and being timed by said engine camshaft for a four stroke cycle diesel engine, so that fuel injection into the diesel engine combustion chamber starts at or near to best diesel engine cycle efficiency timing, and in at least one or more than one separate fuel injection pulses; and further so that fuel injection into the diesel engine combustion chamber can be stopped, by said torque input signal, an adjustable time interval following said start of fuel injection in order to adjust fuel flow per engine cycle and thus engine torque.
